(19) United States
(12) Patent Application Publication
(10) Pub. No.: US 2003/0193949 A1
(43) Pub. Date: Oct. 16, 2003

(54) Packet processing device

(76) Inventors: Yuji Kojima, Kawasaki (JP); Tetsumei Tsuruoka, Kawasaki (JP); Kenichi Abiru, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/374,343

(22) Filed: Feb. 26, 2003

(30) Foreign Application Priority Data
Apr. 15, 2002 (JP) 2002-111514

(51) Int. Cl. H04L 12/28

(52) U.S. Cl. 370/392

(57) ABSTRACT

A packet processing device with an improved architecture which permits a single microcode program to manipulate protocol headers in a unified and efficient way, regardless of differences in their underlying protocol structures. A packet buffer stores a received packet in its fixed-length data registers. An address register stores a protocol header pointer indicating where in the packet buffer a protocol header starts. A field address table stores field location parameters that indicate the locations of each field of a protocol header and specify how to treat such fields. An operation unit manipulates the received packet in the packet buffer, adjusting alignment of each field on a data register boundary according to the protocol header pointer and field location parameters. This architecture enables the same series of instructions to read and/or write fields of a protocol header, regardless of the underlying protocol stack structures.

### BACKGROUND OF THE INVENTION

1. Field of the Invention

The present invention relates to a packet processing device, and more particularly to a packet processing device which executes a program to manipulate received network packets.

2. Description of the Related Art

With the increased use of computers and other data processing equipment, interworking between multiple local area networks (LAN), as well as between LANs and wide area networks (WAN), has become crucially important, and in such internetworking systems, the Internet Protocol (IP) serves as the de facto standard protocol. IP offers connectionless network-layer services based on the Open Systems Interconnection (OSI) model developed by the International Organization for Standardization (ISO). Unlike connection-oriented networks, IP networks need no pre-established communication path between sending and receiving stations. Rather, intermediary devices on a network receive and forward data packets toward specified destinations, examining their header field to determine which way they should go.

Packet routing devices actually execute various tasks to route each packet, which include: parsing header information to identify what packet format is used, calculating header checksum, searching routing tables, and modifying the packet header as necessary, according to the packet format identified. They are further required to implement packet filtering functions, which control particular types of network traffic by analyzing incoming packets and letting them pass or halting them based on their destination addresses.

To provide the above-described features, most packet routing devices employ a dedicated processor that execute programs for routing and filtering packets. Such a software approach is preferable because in-field update capabilities are required for them to keep up with the advancement of protocol specifications. Microcode-based packet processors have therefore been developed and used in these years to permit design engineers to write a desired sequence of instructions with a machine-level language.

Conventional packet processors are, however, not always convenient in terms of access to protocol headers in a packet. Think of, for example, an IP message encapsulated in a lower-layer frame. The processor employs a protocol processing program to manipulate information in the IP header. The problem is that this program has to read and write different portions of a packet when dealing with IP messages delivered with different lower layer protocols, because the absolute location of IP header in an incoming packet depends on the length of the underlying protocol's header. This means that the instructions to handle IP header data must have different operands to specify where each field lies, thus demanding the programmers to produce different codes depending on the protocol header structure of encapsulated packets. This raises the workloads in program development, as well as requiring more program memory.

### SUMMARY OF THE INVENTION

In view of the foregoing, it is an object of the present invention to provide a packet processing device with an improved architecture which enables programmers to write a microcode program in a more unified and efficient way, without the needs for considering differences in the underlying protocol structures.

To accomplish the above object, according to the present invention, there is provided a packet processing device for processing received packets with a series of instructions. This device comprises the following elements: a packet buffer for storing a received packet, comprising a plurality of data registers with a fixed data length; an address register storing a protocol header pointer indicating where in the packet buffer a protocol header starts; a field address table storing field location parameters that indicate locations of fields constituting the protocol header and specify how to treat the fields; and an operation unit which manipulates the received packet, adjusting alignment of each field on a data register boundary of the packet buffer according to the protocol header pointer in the address register and the field location parameters in the field address table, whereby the same series of instructions can be used to read and/or write a particular field, regardless of protocol stack structure of the received packet.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a packet processing device according to the present invention;

FIG. 2 shows the format of an IP packet carried over DIX Ethernet transport;

FIG. 3 shows the format of an IP packet carried over Ethernet SNAP transport;

FIG. 4 shows how the packet processing device makes access to a packet buffer according to a first embodiment of the present invention;

FIG. 5 shows the specifics of field location parameters stored in a field address table;

FIG. 6 shows functional blocks of an operation unit which are used to read a specified field of a packet header;

FIGS. 7 and 8 show the structure of first and second source register selectors according to the first embodiment;

FIG. 9 shows the structure of a first field extractor according to the first embodiment;

FIG. 10(A) shows a rotate-right operation;

FIG. 10(B) shows a rotate-left operation;

FIG. 11 shows the structure of a second field extractor according to the first embodiment;

FIG. 12 shows functional blocks of the operation unit which are used to write a specified field;

FIGS. 13 and 14 show the structure of a first field writer according to the first embodiment;

FIGS. 15 and 16 show the structure of a second field writer according to the first embodiment;

FIG. 17 shows how the packet processing device makes access to a packet buffer in a second embodiment of the present invention;

FIG. 18 shows an example of an IP packet stored in the packet buffer according to the second embodiment;

FIG. 19 shows another example of an IP packet stored in the packet buffer according to the second embodiment;

FIGS. 20 and 21 show the structure of first and second source register selectors according to the second embodiment;

FIGS. 22 and 23 show the structure of first and second field extractors according to the second embodiment;

FIG. 24 shows the structure of a first field writer according to the second embodiment;

FIG. 25 shows a register bitmap;

FIG. 26 shows the operation of a first source register selector and a first destination register selector according to a third embodiment;

FIG. 27 shows the operation of a second source register selector and a second destination register selector according to the third embodiment;

FIG. 28 shows the concept of a packet processing device according to a fourth embodiment of the present invention;

FIG. 29 outlines how the fourth embodiment operates;

FIG. 30 outlines a variation of the fourth embodiment; and

FIG. 31 shows a fifth embodiment of the present invention.

### DESCRIPTION OF THE PREFERRED EMBODIMENTS

Preferred embodiments of the present invention will be described below with reference to the accompanying drawings, wherein like reference numerals refer to like elements throughout.

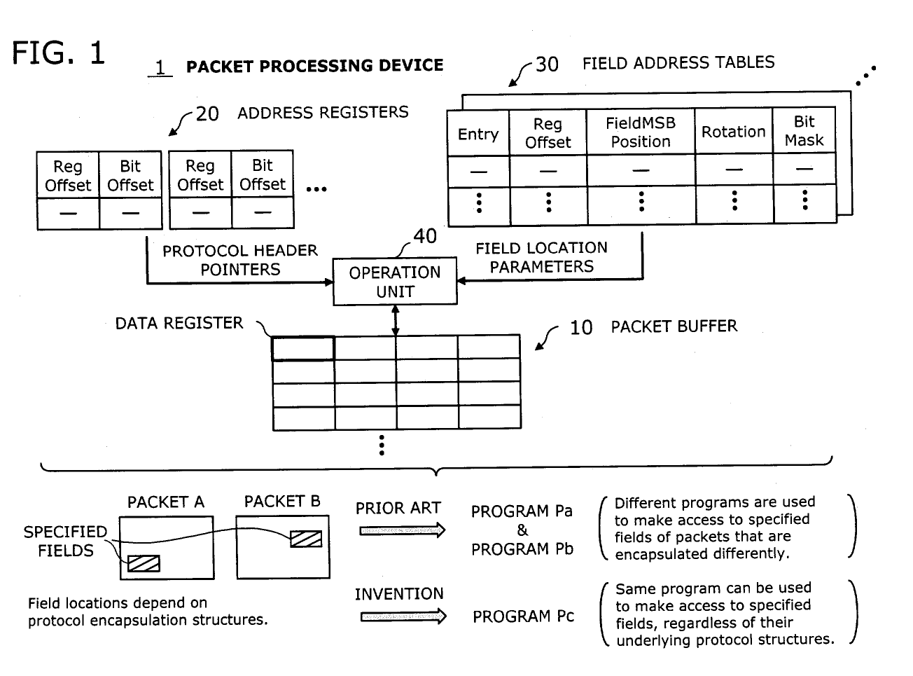

FIG. 1 is a conceptual view of a packet processing device according to the present invention. This packet processing device 1 processes received network packets according to a series of instructions (microcodes), i.e., a program. The packet processing device 1 is designed for use in network equipment such as a packet routing device (e.g., IP routers) which forwards packets over a network, looking up routing tables and modifying the header information as necessary.

The packet processing device 1 has a packet buffer 10, address registers 20, field address tables 30, and an operation unit 40. The packet buffer 10 is composed of a plurality of fixed-length data registers to store a received packet that contains an encapsulated protocol message. The address registers 20 indicate the start point of each protocol header in a packet that is currently stored in the packet buffer 10. The information in an address register is thus referred to as a “protocol header pointer.” The field address tables 30 hold data for the operation unit 40 to locate individual fields in each protocol header, and other parameters used to process them. The contents of those field address tables 30 are referred to herein as “field location parameters.”

The protocol header pointers in the address registers 20 are updated each time a new packet is received, whereas the field location parameters have previously been set in the field address tables 30 as common library data for the packet handling programs. Based on such protocol header pointers and field location parameters, the operation unit 40 extracts and/or modifies specified fields of each received packet, while adjusting their positions in such a way that the most significant bit (MSB) or least significant bit (LSB) of specified field data will be aligned on a data register boundary in the packet buffer 10. The operation unit 40 executes those tasks with a single program in a unified manner, regardless of what underlying protocols are used to carry the message, as long as their field location parameters are registered in the field address tables 30.

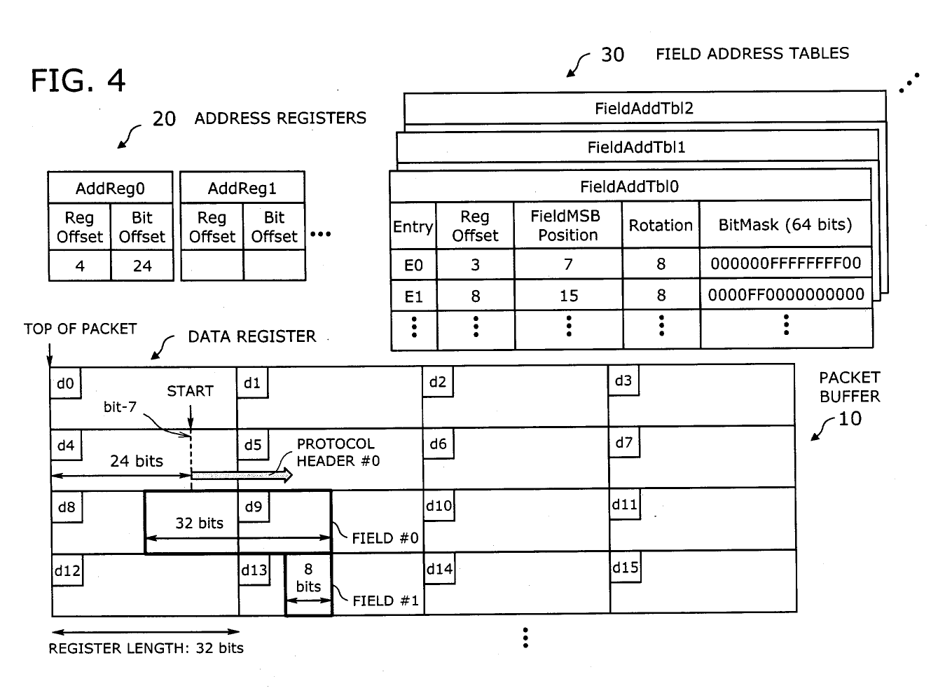

The bottom part of FIG. 1 shows two example packets A and B, where the hatched boxes represent a particular field of a particular protocol header. While they serve the same function, the two fields are found in different locations since the packets A and B have different protocol encapsulation structures. In such cases, conventional processing devices would require two different programs Pa and Pb to manipulate those fields, because of the difference in their underlying layer protocols. The present invention, however, can handle both packets A and B with a single program Pc, regardless of their protocol encapsulation structures. We will provide more specifics about the structure and functions of the proposed device 1 in a later section, with reference to FIG. 4 and subsequent drawings. Before doing that, we elaborate what the present invention intends to solve in the following section.

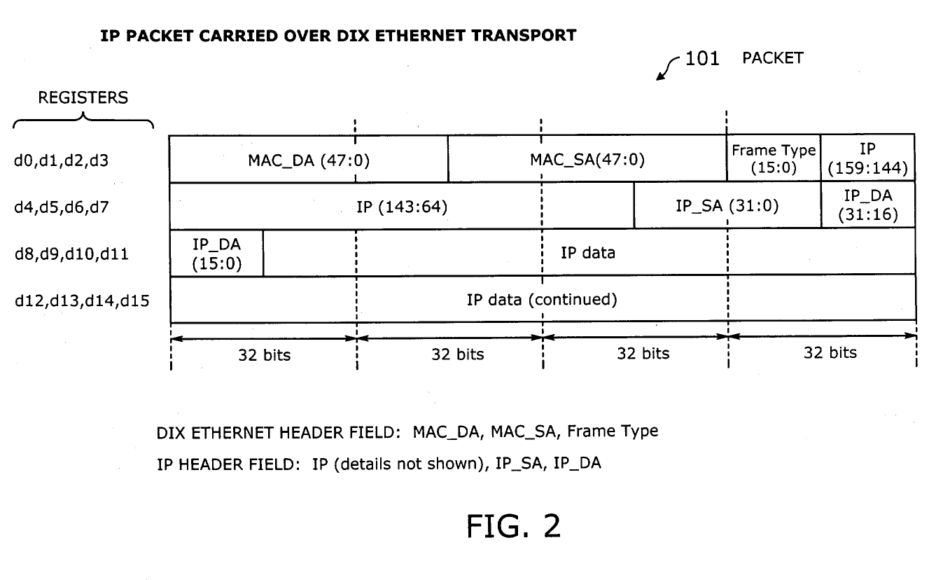

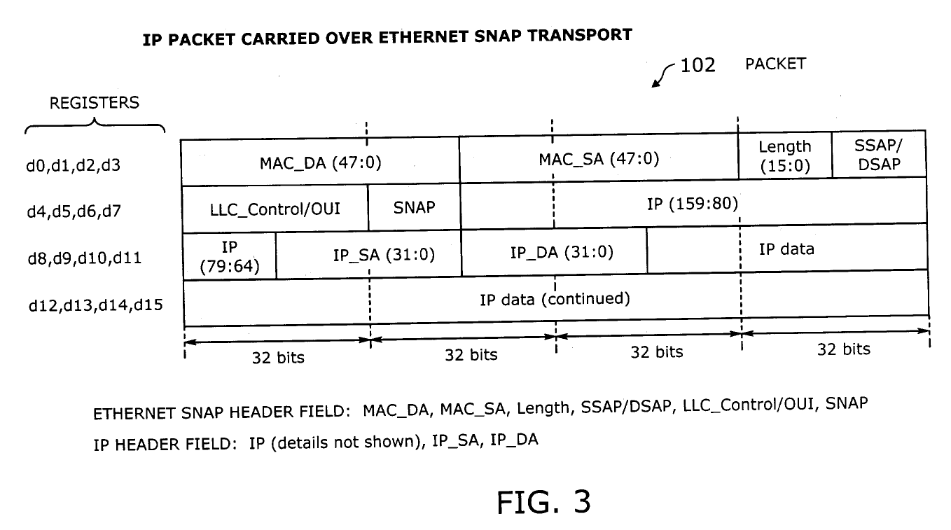

FIGS. 2 and 3 give two examples of a received packet in the packet buffer 10. Specifically, FIG. 2 shows an IP packet 101 in DIX Ethernet framing that is used as its data link layer protocol, while FIG. 3 shows another IP packet 102 encapsulated in an Ethernet SNAP data link frame. Ethernet is a trademark of Xerox Corporation USA, DIX stands for “Digital, Intel, Xerox,” (consortium that created the initial Ethernet standard), and SNAP is an acronym for “Subnetwork Access Protocol.” For both FIGS. 2 and 3, the following notation applies: “***_SA” and “***_DA” denote ***-layer source and destination addresses, and “(n1:n2)” indicates the length of a field in the form of a bit number pair, n1 for MSB and n2 for LSB. The following abbreviations are also used: MAC for “Media Access Control” (lower half of data link layer), SSAP for “Source Service Access Point,” DSAP for “Destination Service Access Point,” LLC for “Logical Link Control” (upper half of data link layer), and OUI for “Organizationally Unique Identifier.”

Typically, a packet begins with a plurality of protocol-specific packet headers which are followed by user data. Protocol headers are concatenated one after another in the order of encapsulation, from the lowest layer to the highest layer. In the illustrated examples, an IP header is nested on a DIX or SNAP Ethernet header, and IP data follows them.

Each packet header consists of a plurality of fields (e.g., MAC_DA, MAC_SA). The location of each header in a packet depends on with what protocol stack the packet is constructed. FIGS. 2 and 3 illustrate such a situation where two identical IP packets encapsulated in different data link layer protocols, DIX Ethernet (FIG. 2) and Ethernet SNAP (FIG. 3). As can be seen from those drawings, their IP headers are located in different places even though both of them conform to the same network layer protocol, IP. More specifically, the IP header in the DIX Ethernet-encapsulated packet 101 starts at the fourth data register d3, while that of the Ethernet SNAP-encapsulated packet 102 starts at the sixth data register d5. Within a packet header of a particular protocol, on the other hand, each data field is placed in a fixed position relative to the top of the header. Take the IP_SA field, for example. This 32-bit source address field (bit#32 to bit#63 of IP header) is located at the thirteenth to sixteenth octets with respect to the top of the IP header in either packet 101 or 102.

Such network packets are processed according to a series of microcode instructions written by firmware engineers. Each instruction is composed of the following subfields: modifier, operation code, destination register, and source register. Operation code subfield specifies which logical/arithmetic operation (e.g., addition, subtraction) to perform. Destination register subfield indicates the register to which the operation result will be stored, while source register subfield specifies the source of data to be processed. For example, instructions to manipulate a DIX Ethernet packet 101 using IP_SA as a source operand can be expressed in general form as follows:

Cond Opcode Operand0 d6

Cond Opcode Operand1 d7

where “Cond” is an instruction modifier, “Opcode” is an operation code (e.g., ADD, SUBTRACT), and “Operand0” and “Operand1” represent destination registers. Note that two instructions are required to process the IP_SA field in the DIX Ethernet-encapsulated packet 101 since the IP_SA field lies across two data registers d6 and d7.

The same for the Ethernet SNAP-encapsulated packet 102 shown in FIG. 3 is as follows:

Cond Opcode Operand0 d8

Cond Opcode Operand1 d9

The source registers in this case are d8 and d9, since the IP_SA field lies across those two registers.

As can be seen from the above examples, the instructions for the DIX Ethernet-encapsulated packet 101 read data registers d6 and d7, whereas those for the Ethernet SNAP-encapsulated packet 102 read other data registers d8 and d9 as the data source. In other words, the two packets 101 and 102 require a different instruction sequence to perform an operation on the same IP_SA field, because the IP field locations depend on which data link protocol is used on the underlying layer. For this reason, the firmware engineers have to write two programs to manipulate Ethernet-encapsulated IP packets, one for DIX format and the other for SNAP format. Such a dual design approach is inconvenient and inefficient. For improved efficiency in program development and packet processing, the present invention provides a unified way of handling packets in a multi-protocol environment, with a single program that is designed to operate with various protocol encapsulation structures.

We will now show a specific embodiment of the proposed packet processing device 1. FIG. 4 shows how the packet processing device 1 makes access to the packet buffer 10 according to a first embodiment of the present invention. Here, the packet buffer 10 is composed of sixteen 32-bit data registers d0 to d15 to store received packet data. Packets come in and go out of this packet buffer 10 in a bitwise fashion. The packet processing device 1 can read and write the packet buffer 10 one register at a time, meaning that one program instruction can handle a field of at most 32 bits. When it is necessary to process a longer field that exceeds the register length, the code should be divided in two or more instructions. This constraint holds for both the present invention and prior-art.

According to the present invention, the packet processing device 1 uses the same instruction operand to read or write a particular field of a particular protocol header, no matter what protocols are used in the underlying layers. The length of such fields may range from zero to 32 bits. As already mentioned above, a long field should be divided into parts, so that the device 1 can process them with two or more instructions. In this case, each segment of the field is considered as another independent field, and the firmware designer adds the location parameters for those segments in a relevant field address table. By so doing, the firmware engineer enables the protocol processing device 1 to handle long fields in the same way as it treats short fields; that is, the device 1 can use the same operand to read or write the same field.

More specifically, the elements shown in FIG. 4 have the following functions. The address registers 20 include AddReg0, AddReg1, AddReg2, and so on, corresponding to different protocol headers #0, #1, #2, and so on (only #0 is shown in FIG. 4). For example, the first address register AddReg0 points at protocol header #0, the header of an IP packet stored in the packet buffer 10. Firmware engineers are allowed to define the associations between such address register numbers and protocol headers, according to the requirements of the program that they are developing.

As can be seen from the above example, each address register contains a protocol header pointer that indicates the position of a particular protocol header (e.g., Ethernet header, IP header), relative to the top of the received packet. This pointer consists of “register offset” (RegOffset) and “bit offset” (BitOffset). In the example of FIG. 4, the address register AddReg0 contains a register offset of “4” and a bit offset of “24,” which means that the protocol header #0 begins at bit #7 of data register d4. The following expression will be used to represent a particular protocol header location.

(AddReg0, RegOffset)=4

(AddReg0, BitOffset)=24

Each individual bit of a 32-bit register is designated by its bit position number (e.g., bit #0, #1, . . . #31). Bit #0 is the LSB (or the right-most bit in FIG. 4), and bit #32 is the MSB (or the left-most bit in FIG. 4). The bit offset within a register is given with respect to the MSB of that register; e.g., BitOffset=0 denotes bit #32 of a data register.

The field address tables 30 include FieldAddTb10, FieldAddTb11, FieldAddTb12, and so on, which are associated one-to-one with the above-described address registers AddReg0, AddReg1, and so on. Each field address table stores field location parameters, which include the following items: entry number (“Entry”), field register offset (“RegOffset”), field MSB position (“FieldMSBPosition”), rotation count (“Rotation”), and 64-bit bit mask (“BitMask”).

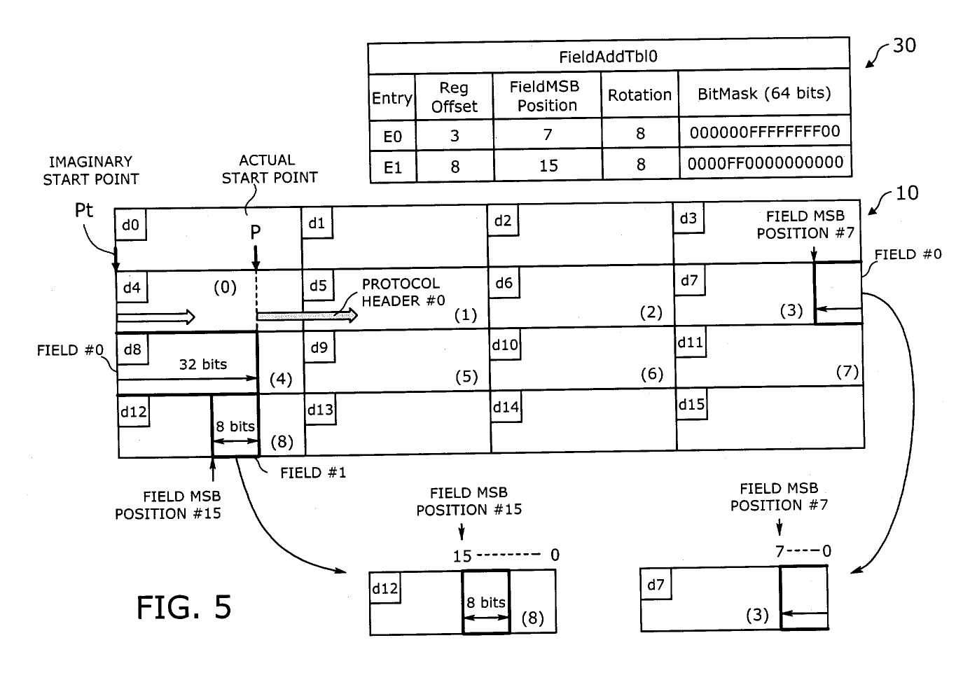

FIG. 5 shows the specifics of field location parameters in the field address table FieldAddTb10. Each entry of the table provides the information about a particular field of a given protocol header. In the example of FIG. 5, the table FieldAddTb10 stores field location parameters of an IP header. Its top-most entry E0 is for field #0 (IP_SA field, actually) and the next entry E1 is for another field #1. The field register offset (RegOffset) indicates in which data register the MSB of that field is found, assuming that the protocol header is aligned on a data register boundary. More specifically, imagine that the protocol header of interest is moved leftward to the extreme end of that row as shown in FIG. 5, and the number of data registers is counted from that left-end register until the MSB of the field is reached. This count value is set in the field address table as the field register offset of that field.

Referring to the example shown in FIG. 5, the protocol header #0 of interest is assumed to begin at an imaginary start point Pt, although it actually starts at point P, bit #7 of data register d4 as described earlier in FIG. 4. To aid the understanding of field register offsets, the parenthesized numbers indicate the displacement of each register relative to that starting register d4. With the above assumption of protocol header alignment, the MSB of field #0 resides in data register d7, which is three registers away from the imaginary start point Pt. This displacement value “three” is registered as the field register offset of field #0 in entry E0 of FieldAddTb10.

We can determine the field register offset of another field #1 (entry E1 of FieldAddTb10) in a similar way. That is, the MSB of field #1 is found in data register d12, which is eight registers away from the starting data register d4. Accordingly, this entry El has a field register offset of “8.”

With the same assumption of protocol header alignment, the field MSB position is defined to be the bit position within a data register at which the MSB of a field of interest is located. In other words, the field MSB position gives the bitwise displacement of a field when its register offset is known. In the example of FIG. 5, the field #0 has a field MSB position of “7” because its MSB is located at bit #7 of data register d7. Likewise, another header field #1 has a field MSB position of “15” because its MSB is found at bit #15 of data register d12.

The remaining parameters in the field address table FieldAddTb10 are “Rotation” and “BitMask (64 bits),” which are used to adjust data alignment with register boundaries. The rotation count parameter (“Rotation”) specifies how many bits to rotate data, and the bit mask parameter (“BitMask”) gives which part of a packet to extract. The detailed usage of these parameters will be described in a later section. Bit masks have to be twice as long as a data register. The length is 64 bits in the present case since each register is 32 bits in length. In the case the registers has a different length, the bit mask length should vary accordingly.

The proposed packet processing device 1 executes a packet processing program written by a firmware engineer. The above-described protocol header pointers in the address registers 20 help the packet processing device 1 to make access to an intended data field on the data registers, as do the field location parameters provided in the field address tables 30. In the next section, we will explain the packet processing program which is designed to manipulate packet fields regardless of protocol encapsulation structures.

The present invention enables the protocol processing device 1 to read and write a particular field of a particular packet header by specifying a combination of an address register and an entry of a corresponding field address table, regardless of what protocols are used to encapsulate the packet. Suppose, for example, that a firmware engineer has to write a program to manipulate the IP_SA field of a received IP header. No matter what underlying layer protocol is used, he/she can reach the IP_SA field by including “AddReg0” and “E0” in instruction code, instead of directly specifying a particular source or destination register. Here, the address register “AddReg0” points at the IP header of interest, and the entry “E0” of FieldAddTb10 designates its IP_SA field. There is no need to change the program even if a different lower-layer protocol is used to encapsulate IP packets.

Here are a few example instructions that the proposed packet processing device 1 executes. First, the following instruction uses field #0 as source operand:

Cond Opcode Operand0 AddReg0 E0

To manipulate field #1, it will be:

Cond Opcode Operand1 AddReg0 E1

The next instruction stores the result in field #0:

Cond Opcode AddReg0 E0 Operand0

When field #1 is the destination, the instruction should be as follows:

Cond Opcode AddReg0 E1 Operand1

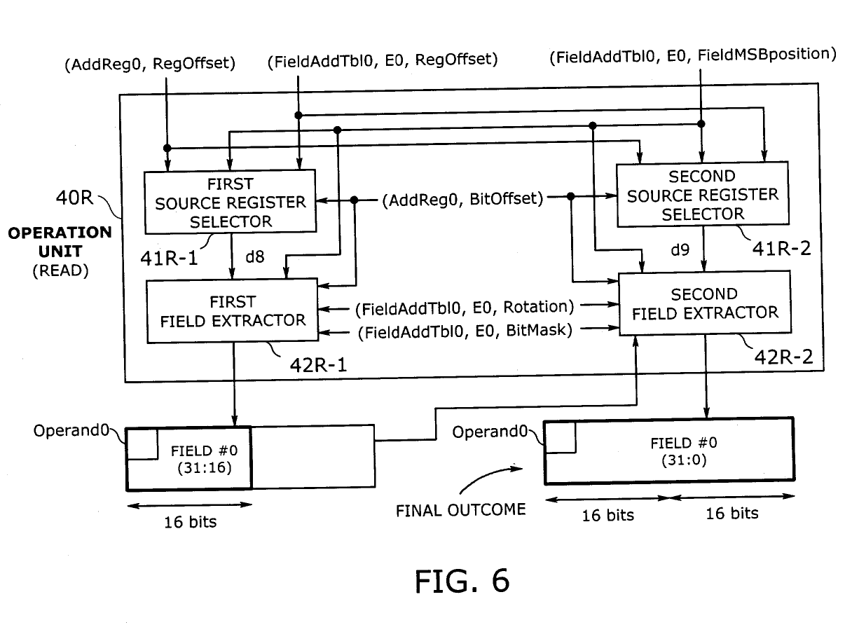

The operation unit 40 in the packet processing device 1 executes such instructions, reading and writing desired fields. Referring now to FIGS. 6 to 11, we will describe how the operation unit 40 reads a specific field and stores the data in a destination register.

FIG. 6 shows functional blocks in the operation unit 40 that are used to read a particular field. This part of the operation unit 40 is referred to by the reference numeral “40R.” The illustrated operation unit 40R comprises a first source register selector 41R-1, a second source register selector 41R-2, a first field extractor 42R-1, and a second field extractor 42R-2. The first and second source register selectors 41R-1 and 41R-2 identify data registers (source registers) which accommodate a specified field. The first and second field extractors 42R-1 and 42R-2 extract field data from the source registers identified, adjust its alignment with a register boundary, and store the result in a specified destination register.

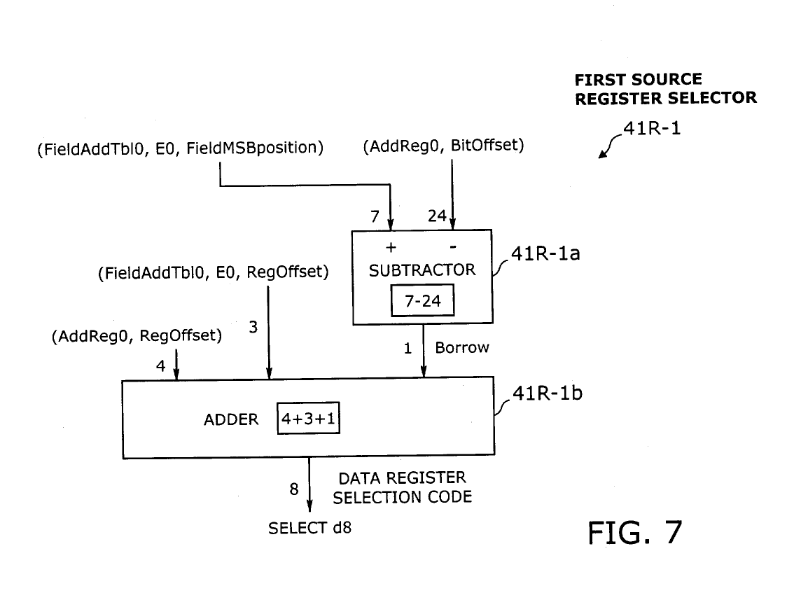

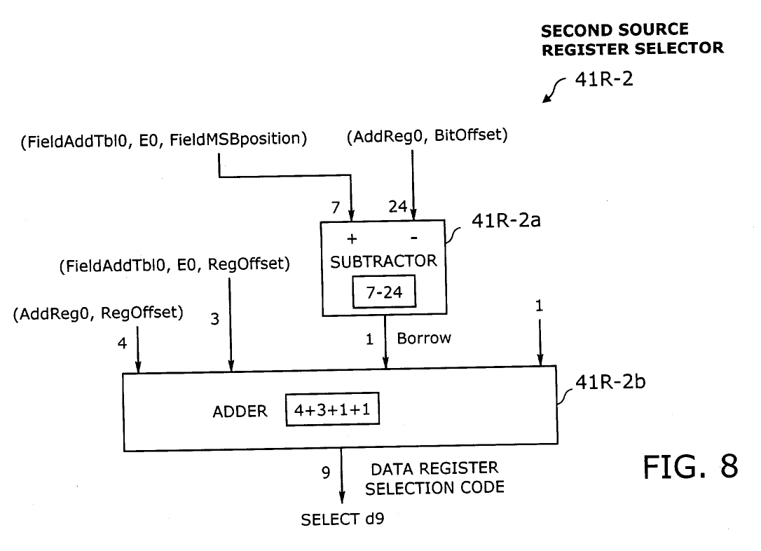

FIG. 7 shows the detailed structure of the first source register selector 41R-1. The given source operand, field #0 in this case, lies across two adjacent data registers d8 and d9 (see also FIG. 4). The first source register selector 41R-1 is designed to select the first source register d8, while the second source register selector 41R-2 is responsible for the second source register d9 (as will be described later in FIG. 8). More specifically, the first source register selector 41R-1 determines which data register to choose, basically by adding the following two given parameters: (AddReg0, RegOffset) and (FieldAddTb10, E0, RegOffset). The exception is when (FieldAddTb10, E0, FieldMSBPosition) is smaller than (AddReg0, BitOffset). In this case, it chooses the register next to the one determined by the above parameters (AddReg0, RegOffset) and (FieldAddTb10, E0, RegOffset).

The first source register selector 41R-1 is composed of a subtractor 41R-1a and an adder 41R-1b. The subtractor 41R-1a calculates the difference between a given minuend (FieldAddTb10, E0, FieldMSBPosition) and subtrahend (AddReg0, BitOffset). In the current example, it calculates (7−24), which makes −17. When the result is a negative number, as in the present case, the subtractor 41R-1a sends a borrow “1” to the adder 41R-1b, indicating that (FieldAddTb10, E0, FieldMSBPosition) is smaller than (AddReg0, BitOffset). The adder 41R-1b calculates the sum of (AddReg0, RegOffset)=4, (FieldAddTb10, E0, RegOffset)=3, and the borrow=1 of the subtractor 41R-1a. The resultant data register selection code “8” suggests that data register d8 be selected as the first source register.

FIG. 8 shows the detailed structure of the second source register selector 41R-2. As already stated, the second source register selector 41R-2 is supposed to select the second source register d9 in the present context. It has a subtractor 41R-2a and an adder 41R-2b, which operate basically in the same way as those in the first source register selector 41R-1 do. The only difference is that the second source register selector 41R-2 is given an extra increment “1” to designate the next data register that follows the one selected by the first source register selector 41R-1. Specifically, the adder 41R-2b calculates the sum of (AddReg0, RegOffset)=4, (FieldAddTb10, E0, RegOffset)=3, borrow=1, and an extra increment “1.” The resultant data register selection code “9” suggests that data register d9 be selected as the second source register.

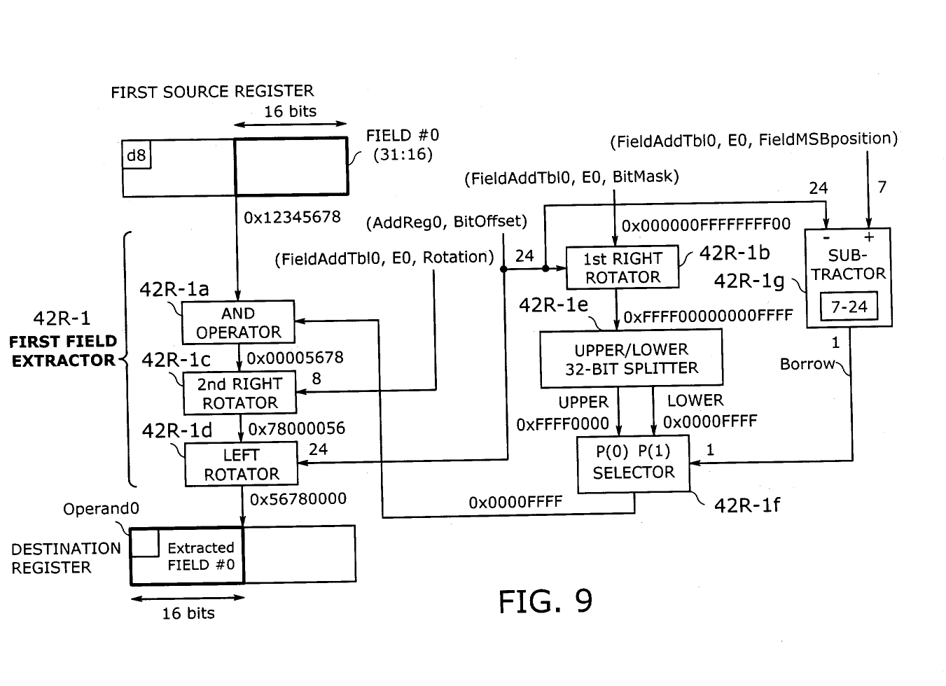

FIG. 9 shows the structure of the first field extractor 42R-1. The first field extractor 42R-1 extracts misaligned field data from a specified data register, corrects its alignment with a register boundary, and replaces a relevant part of the destination register with the realigned field data. In the current example, the first half of field #0 is located in the lower 16-bit portion of data register d8. Accordingly, the first field extractor 42R-1 extracts this field data from d8, realigns it on the left side, and puts it in the upper 16 bits of the destination register specified by Operand0.

The first field extractor 42R-1 accomplishes the above function with the following elements: an AND operator 42R-1a, a first right rotator 42R-1b, a second right rotator 42R-1c, a left rotator 42R-1d, an upper/lower 32-bit splitter 42R-1e, a selector 42R-1f, and a subtractor 42R-1g. The subtractor 42R-1g subtracts (AddReg0, BitOffset) from (FieldAddTb10, E0, FieldMSBPosition), thereby determining which is smaller. Since the latter “7” is smaller than the former “24” in the present example, the subtractor 42R-1g sends a borrow “1” to the selector 42R-1f. The first right rotator 42R-1b, on the other hand, rotates right the given bit mask pattern (FieldAddTb10, E0, BitMask), which is “0x000000FFFFFFFF00,” by a number specified by (AddReg0, BitOffset), which is “24” in the present example. This rotation produces a bit mask pattern of “0xFFFF00000000FFFF,” where the suffix “0x” denotes a hexadecimal number. The details of rotation of registers will be described later.

The 64-bit output of the first right rotator 42R-1b is then directed to the upper/lower 32-bit splitter 42R-1e, which divides it into upper and lower halves, thus supplying the selector 42R-1f with the upper 32 bits “0xFFFF0000” and lower 32 bits “0x0000FFFF.” The selector 42R-1f has two input ports: port P(0) for upper 32-bit data, and port P(1) for lower 32-bit data. The selection depends on the borrow bit output of the subtractor 42R-1g, and in the current example, the selector 42R-1f chooses the lower 32-bit data “0x0000FFFF” at port P(1) since the borrow bit is set to “1.”

The selector output “0x0000FFFF” is used by the AND operator 42R-1a to mask the value of data register d8, which is assumed to be “0x12345678” in the present example. The result is “0x00005678.” The second right rotator 42R-1c rotates right this data by a rotation count specified in (FieldAddTb10, E0, Rotation), which is “8.” The resulting value “0x78000056” is then supplied to the left rotator 42R-1d, which rotates it leftward by a number specified in (AddReg0, BitOffset). Since this BitOffset is “24,” the left rotation of “0x78000056” yields “0x56780000.”

Through the above arithmetic and logic operations, the first field extractor 42R-1 obtains “0x56780000” out of the original value “0x12345678” in data register d8. This means that the first field extractor 42R-1 has extracted the upper 16 bits of field #0 from the first source register d8, and the extracted 16-bit data has been set to the upper 16-bit portion of the destination register specified by Operand0.

The above process involves right rotation and left rotation of a register. More specifically, a rotate-right operation moves all bits in a register to the right by a specified rotation count. The tail bits pushed off the register are then inserted to the top location, which is now vacant. A rotate-left operation, on the other hand, moves all bits in a register to the left. The top bits pushed off the register are then inserted to the tail location, which is now vacant. For example, one-bit right rotation of a binary value “1011” yields “1101,” while one-bit left rotation of the same yields “0111.”

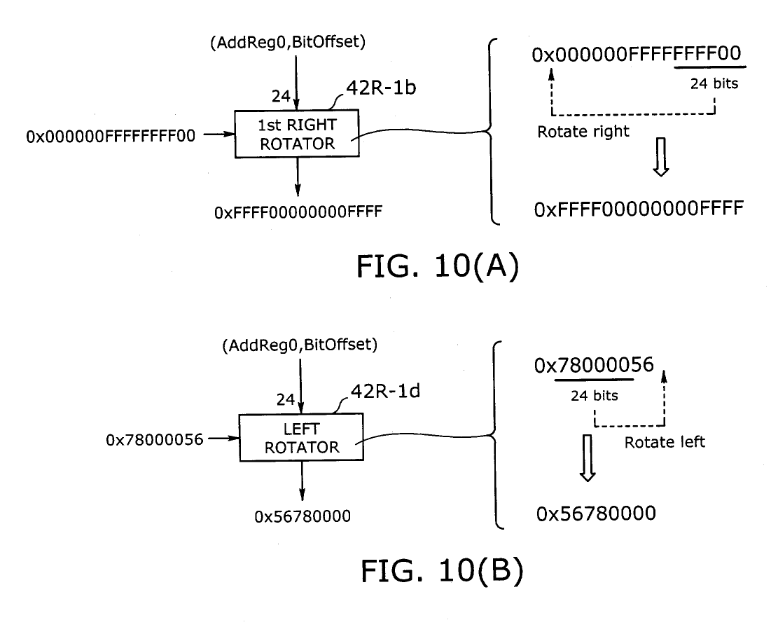

FIG. 10(A) illustrates how the first right rotator 42R-1b performs a rotate-right operation. Given a 64-bit binary string “0x000000FFFFFFFF00” and a rotation count of (AddReg0, BitOffset)=24, the first right rotator 42R-1b moves the lower 24 bits “FFFF00” to the top location, while shifting the entire data rightward. This right rotation thus yields “0xFFFF00000000FFFF.”

FIG. 10(B) shows how the left rotator 42R-1d performs a rotate-left operation. Given a 32-bit binary string “0x78000056” and a rotation count of (AddReg0, BitOffset)=24, the left rotator 42R-1d moves the upper 24 bits “780000” to the tail location, while shifting the entire data leftward. This left rotation thus yields “0x56780000.”

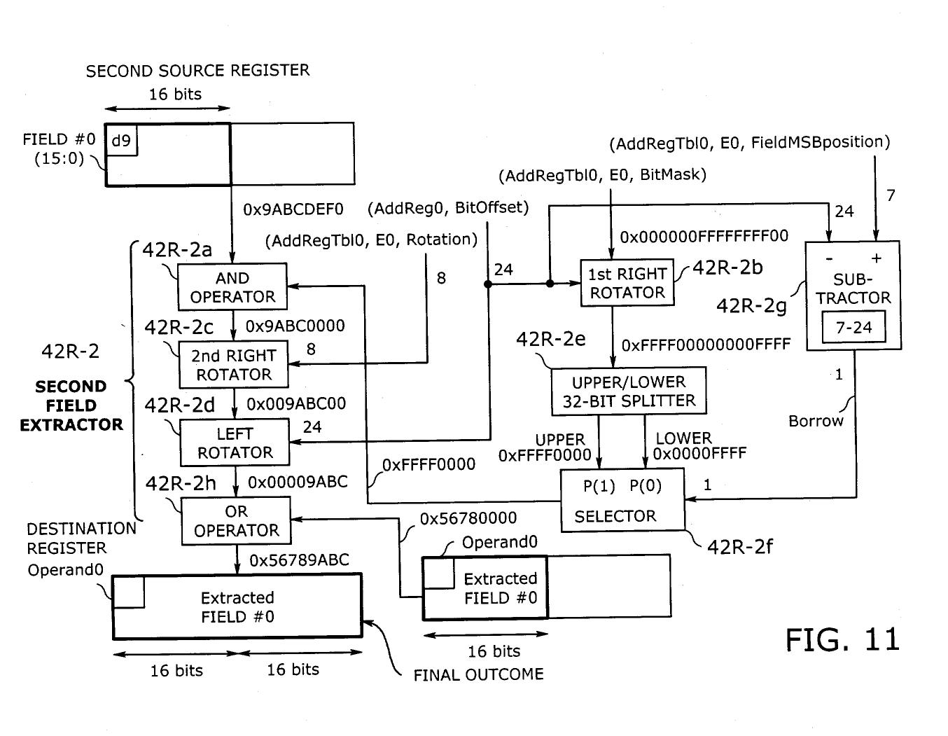

FIG. 11 shows the structure of the second field extractor 42R-2. As has been explained in FIG. 9, the first field extractor 42R-1 has filled the upper half of the specified destination register. The second field extractor 42R-2 extracts the rest of the specified field from the second source register and inserts it to the lower half of the destination register, which is still vacant now. In the current example, the second half of field #0 is located in the upper 16-bit portion of data register d9. Accordingly, the second field extractor 42R-2 extracts this field data from d9 and stores it in the lower 16-bit portion of the destination register that is specified by Operand0. The second field extractor 42R-2 implements the above function by combining the following elements: an AND operator 42R-2a, a first right rotator 42R-2b, a second right rotator 42R-2c, a left rotator 42R-2d, an upper/lower 32-bit splitter 42R-2e, a selector 42R-2f, a subtractor 42R-2g, and an OR operator 42R-2h.

The subtractor 42R-2g subtracts (AddReg0, BitOffset) from (FieldAddTb10, E0, FieldMSBPosition), thereby identifying which is smaller. Since the latter “7” is smaller than the former “24” in the present example, the subtractor 42R-2g sends a borrow “1” to the selector 42R-2f. The first right rotator 42R-2b, on the other hand, rotates right the given bit mask pattern (FieldAddTb10, E0, BitMask), which is “0x000000FFFFFFFF00,” by a specified rotation count of (AddReg0, BitOffset), which is “24.” This operation yields a pattern of “0xFFFF00000000FFFF.” The upper/lower 32-bit splitter 42R-2e then divides it into upper and lower halves, thus supplying the selector 42R-2f with the upper 32 bits “0xFFFF0000” and lower 32 bits “0x0000FFFF.” The selector 42R-2f has two input ports: port P(0) for the lower 32 bits, and port P(1) for the upper 32 bits. The selector 42R-2f relies its selection control on the borrow bit output of the subtractor 42R-2g. In the current example, the selector 42R-2f chooses the upper 32-bit data “0xFFFF0000” at port P(1) since the borrow bit is set to “1.”

The selector output “0xFFFF0000” is used by the AND operator 42R-2a to mask the second source register d9, which is assumed to be “0x9ABCDEF0” in the present example. The result is “0x9ABC0000.” The second right rotator 42R-2c rotates right this by a specified rotation count of (FieldAddTb10, E0, Rotation), which is “8” in the present case. The resulting value “0x009ABC00” is then directed to the left rotator 42R-2d, which rotates it to the left by a number specified in (AddReg0, BitOffset). Since this BitOffset is 24, the left rotation of “0x009ABC00” yields “0x00009ABC.” Finally, the OR operator 42R-2h combines the two halves of field #0 (i.e., “0x56780000” from the first field extractor 42R-1 and “0x00009ABC” from the left rotator 42R-2d), thus producing a value of “0x56789ABC” for the destination register specified by Oprand0.

The above arithmetic and logic operations extract “0x0009ABC” out of “0x9ABCDEF0” in the second source register (i.e., data register d9), which is the lower 16 bits of the specified field #0. The extracted 16-bit data is then inserted to the lower half of the destination register specified by Operand0. As can be seen from FIGS. 9 and 11, the operation unit 40R identifies source registers in which a specified field resides and extracts relevant parts from them, with the same set of microcode instructions, no matter what underlying-layer protocols are used.

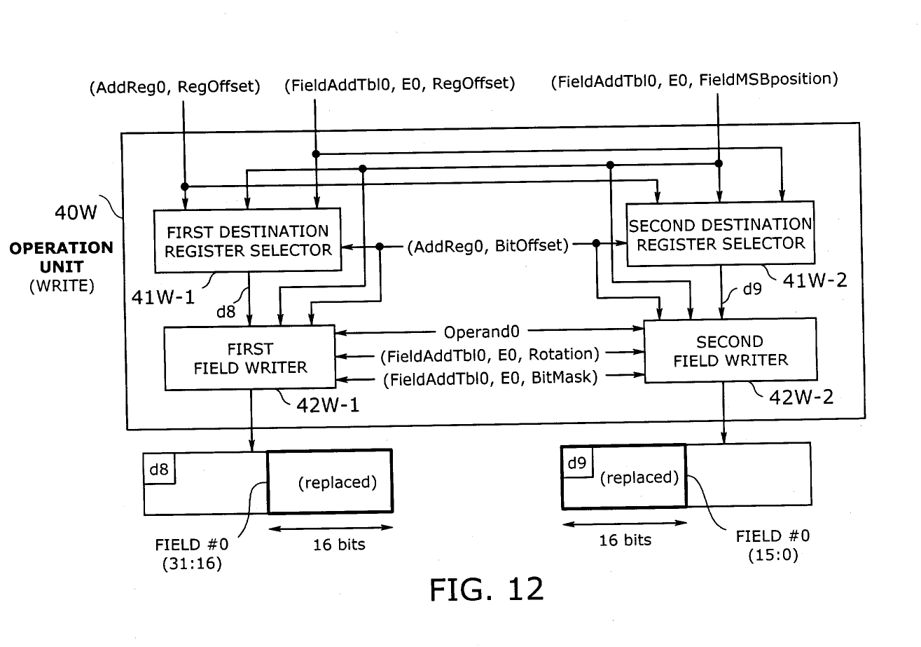

Referring now to FIGS. 12 to 16, we will describe how the operation unit 40 writes given source register data in a specified field of a destination register. FIG. 12 shows functional blocks of the operation unit 40 used to write a specified field, which are collectively referred to by the reference numeral “40W.” The operation unit 40W has first and second destination register selectors 41W-1 and 41W-2, and first and second field writers 42W-1 and 42W-2. The two destination register selectors 41W-1 and 41W-2 determine in which data register(s) the specified field lies. In the present case, they designate d8 and d9 as the first and second destination registers. In terms of the internal structure and operation, those destination register selectors 41W-1 and 41W-2 are identical to the first and second source register selectors 41R-1 and 41R-2 described earlier in FIGS. 7 and 8. See the description of FIGS. 7 and 8 for details.

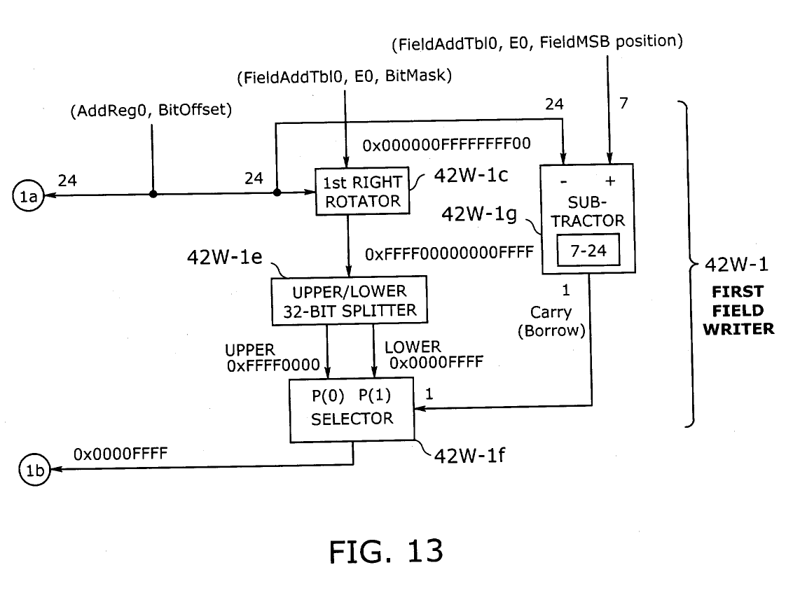

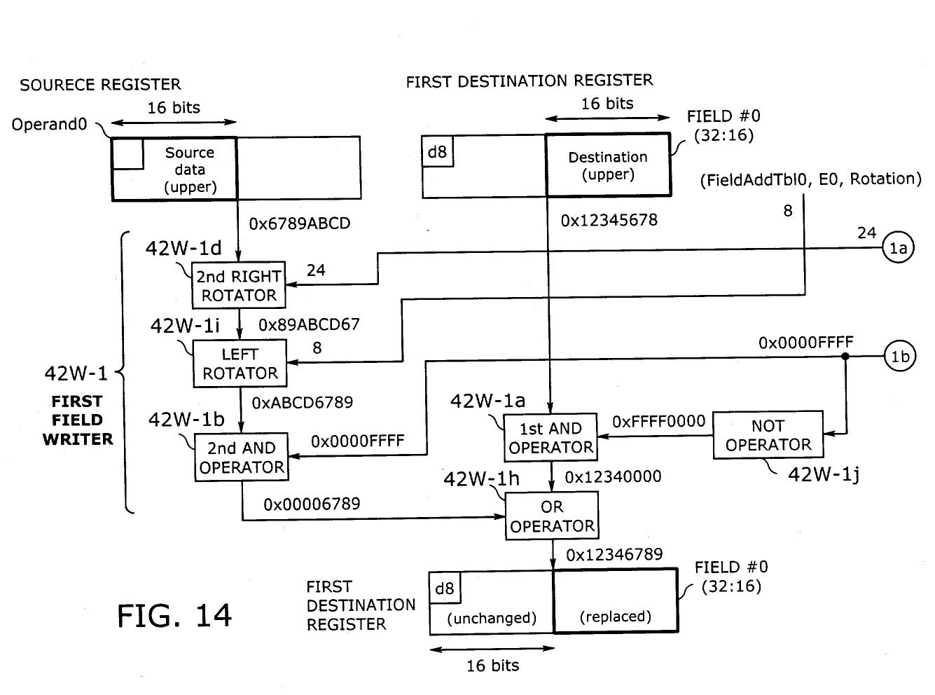

The role of the first and second field writers 42W-1 and 42W-2 is to write given source data to a specified field in the destination registers selected by the first and second destination register selectors 41W-1 and 41W-2, while manipulating the data alignment. FIGS. 13 and 14 show the detailed structure of the first field writer 42W-1, which selectively replaces the lower 16 bits of the first destination register d8 (i.e., the first half of field #0) with given source data, while leaving the remaining bits as they are. To achieve this function, the first field writer 42W-1 has the following elements: a first AND operator 42W-1a, a second AND operator 42W-1b, a first right rotator 42W-1c, a second right rotator 42W-1d, an upper/lower 32-bit splitter 42W-1e, a selector 42W-1f, a subtractor 42W-1g, an OR operator 42W-1h, a left rotator 42W-1i, and a NOT operator 42W-1j.

Referring to FIG. 13, the subtractor 42W-1g subtracts (AddReg0, BitOffset) from (FieldAddTb10, E0, FieldMSBPosition), thereby identifying which is smaller. Since the latter “7” is smaller than the former “24” in the present example, it sends a borrow “1” to the selector 42W-1f. The first right rotator 42W-1d, on the other hand, rotates right a given bit mask pattern (FieldAddTb10, E0, BitMask) by a specified rotation count of (AddReg0, BitOffset). In FIG. 13, the bit mask “0x000000FFFFFFFF00” is rotated by 24 bits, resulting in a pattern of “0xFFFF00000000FFFF.” The upper/lower 32-bit splitter 42W-1e then divides it into two halves, thus supplying the upper 32 bits “0xFFFF0000” and lower 32 bits “0x0000FFFF” to port P(0) and port P(1) of the selector 42W-1f, respectively. The selector 42W-1f selects either pattern according to the borrow bit output of the subtractor 42W-1g. In the current example, it chooses the lower 32-bit data “0x0000FFFF” at port P(1) since the borrow bit is set to “1.”

Referring next to FIG. 14, the NOT operator 42W-1j produces a complementary mask pattern “0xFFFF0000” by logically negating the 32-bit mask pattern “0x0000FFFF” supplied from the selector 42W-1f. This pattern “0xFFFF0000” is used by the first AND operator 42W-1a to mask the first destination register d8, which is assumed to be “0x12345678” in the present example.

The second right rotator 42W-1d, on the other hand, is supplied with source data “0x6789ABCD” from the source register specified by Operand0. The second right rotator 42W-1d rotates right this data by a number specified by (AddReg0, BitOffset), which is now set to “24.” The resultant value “0x89ABCD67” is then sent to the left rotator 42W-1i, which rotates left it by a rotation count of (FieldAddTb10, E0, Rotation), which is “8” in the present example. This left rotation yields a value of “0xABCD6789.” The second AND operator 42W-1b calculates the logical product of this value “0xABCD6789” and the mask pattern output “0x0000FFFF” of the selector 42W-1f, thus obtaining “0x00006789.” The masked result “0x00006789” is then supplied to the OR operator 42W-1h for a logical sum operation with the output “0x12340000” of the first AND operator 42W-1a. The OR operator 42W-1h thus outputs “0x12346789” as write data to the first destination register d8.

The above arithmetic and logic operations change the value of data register d8 from “0x12345678” to “0x12346789.” This means that the first field writer 42W-1 has replaced the upper 16 bits of field #0 in the first destination register (data register d8) with the upper 16 bits of the source register specified by Operand0.

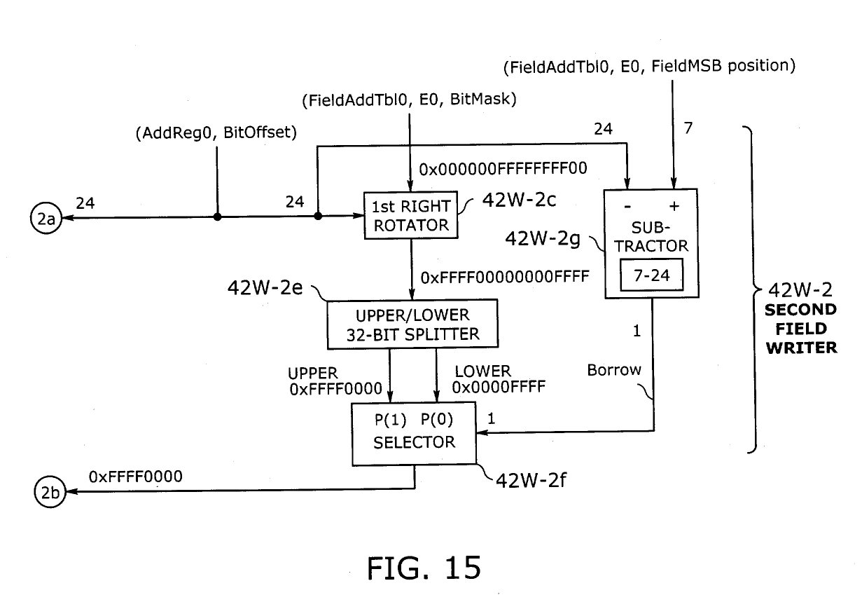

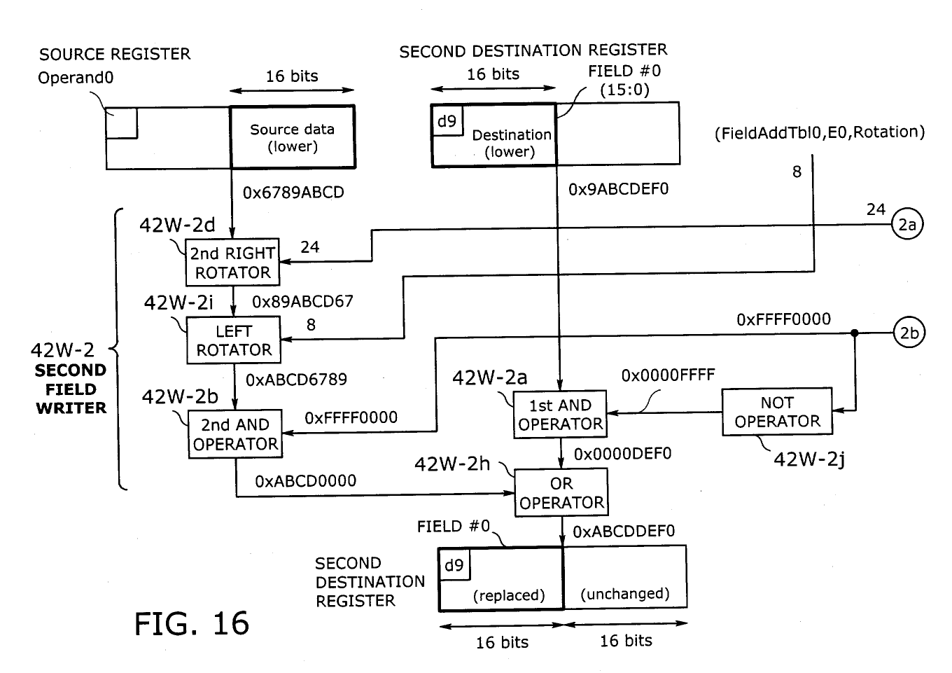

FIGS. 15 and 16 show the detailed structure of the second field writer 42W-2, which selectively replaces the upper 16 bits of the second destination register d9 (i.e., the second half of field #0) with given source data, while leaving the remaining bits as they are. To achieve this function, the second field writer 42W-2 has the following elements: a first AND operator 42W-2a, a second AND operator 42W-2b, a first right rotator 42W-2c, a second right rotator 42W-2d, an upper/lower 32-bit splitter 42W-2e, a selector 42W-2f, a subtractor 42W-2g, an OR operator 42W-2h, a left rotator 42W-2i, and a NOT operator 42W-2j.

Referring to FIG. 15, the subtractor 42W-2g subtracts (AddReg0, BitOffset) from (FieldAddTb10, E0, FieldMSBPosition), thereby identifying which is smaller. Since the latter “7” is smaller than the former “24” in the present example, it sends a borrow “1” to the selector 42W-2f. The first right rotator 42W-2c, on the other hand, rotates right the given bit mask pattern (FieldAddTb10, E0, BitMask) by a number specified in (AddReg0, BitOffset). In FIG. 15, it shifts “0x000000FFFFFFFF00” rightward by 24 bits, thus producing a pattern of “0xFFFF00000000FFFF.” The upper/lower 32-bit splitter 42W-2e then divides it into halves, thus supplying the upper 32 bits “0xFFFF0000” and lower 32 bits “0x0000FFFF” to port P(1) and port P(0) of the selector 42W-2f, respectively. The selector 42W-2f selects either pattern according to the borrow bit output of the subtractor 42W-2g. In the current example, it chooses the upper 32-bit data “0xFFFF0000” at port P(1) since the borrow bit is set to “1.”

Referring to FIG. 16, the NOT operator 42W-2j produces a complementary mask pattern “0x0000FFFF” by logically negating the above mask pattern “0xFFFF0000” supplied from the selector 42W-2f. This pattern “0x0000FFFF” is used by the first AND operator 42W-2a to mask the second destination register d9, which is assumed to be “0x9ABCDEF0” in the present example.

The second right rotator 42W-2d, on the other hand, is supplied with source data “0x6789ABCD” from the source register specified by Operand0. It rotates right this data by a number specified in (AddReg0, BitOffset), which is now set to “24.” The resultant value “0x89ABCD67” is then sent to the left rotator 42W-2i, which rotates left it by a rotation count of (FieldAddTb10, E0, Rotation), which is “8” in the present example. This left rotation yields a value of “0xABCD6789.” The second AND operator 42W-2b calculates the logical product of this value “0xABCD6789” and the mask pattern output “0xFFFF0000” of the selector 42W-2f, thus obtaining “0xABCD0000.” The masked result “0xABCD0000” is then directed to the OR operator 42W-2h for a logical sum operation with the output “0x0000DEF0” of the first AND operator 42W-2a. The OR operator 42W-2h thus outputs “0xABCDDEF0” as the write data to the second destination register d9.

The above arithmetic and logic operations changes the value of data register d9 from “0x9ABCDEF0” to “0xABCDDEF0.” That is, the second field writer 42W-2 replaces the lower 16 bits of field #0 in the second destination register d9 with the lower 16 bits of the source register specified by Operand0. As can be seen from FIGS. 12 to 16, the operation unit 40w identifies destination registers in which the specified field resides and replaces their relevant part with given source data, with the same set of microcode instructions, no matter what underlying-layer protocols are used.

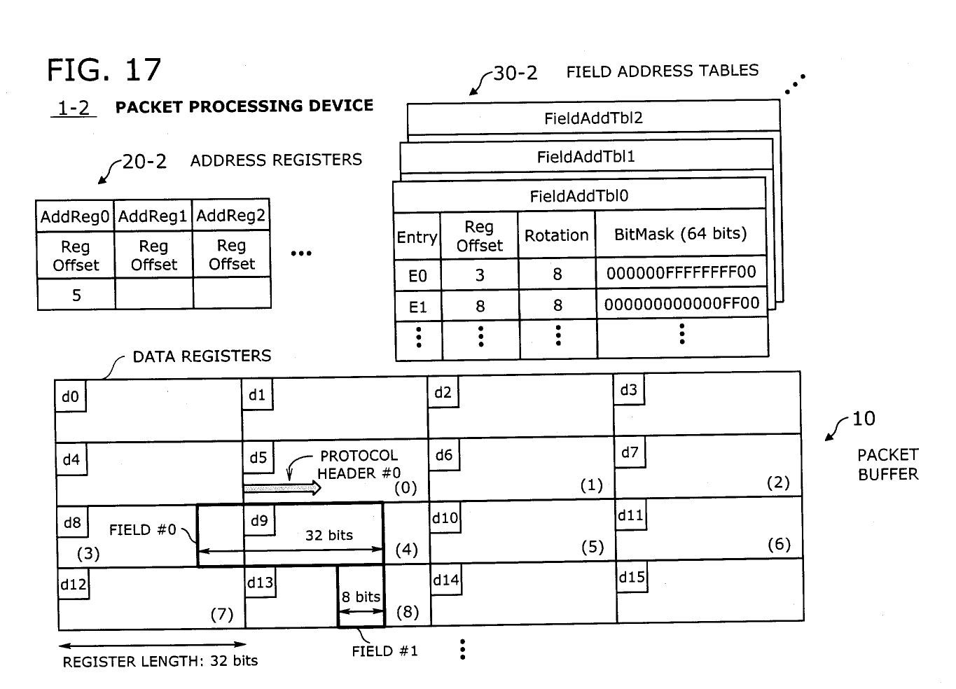

Referring now to FIGS. 17 to 24, we will describe a second embodiment of the present invention. According to the second embodiment, the packet processing device further employs a packet preprocessor which adds padding to each received packet, so that its protocol header will be aligned with a data register boundary, before subjecting the packet to a packet processing program.

FIG. 17 shows how a packet processing device 1-2 makes access to a packet buffer in the second embodiment of the present invention. Since the second embodiment shares similar elements and functions with the first embodiment, we will focus on their differences. First, address registers are simplified in the second embodiment. The packet processing device 1-2 has a plurality of address registers 20-2, including AddReg0, AddReg1, AddReg2, and so on, each of which stores only a register offset (“RegOffset”) for locating a protocol header in the packet buffer 10. FIG. 17 shows an example where a packet has been processed by the packet preprocessor (not shown) in such a way that protocol header #0 be aligned with an appropriate register boundary, which is the MSB of data register d5 in this case. The corresponding address register AddReg0 thus contains a register offset value (AddReg0, RegOffset) of “5.” In FIG. 17, the parenthesized numbers (0), (1), and the like indicate the displacement of each register relative to that starting register d5.

The packet processing device 1-2 also has a plurality of field address tables 30-2, including FieldAddTb10, FieldAddTb11, FieldAddTb12, and so on. It should be noted that the column of field MSB position is missing in the second embodiment. That is, the field location parameters in the second embodiment include the following items: entry number (“Entry”), field register offset (“RegOffset”), rotation count (“Rotation”), and 64 bit bit mask (“BitMask”). Those field location parameters, together with protocol header pointers in the address registers 20-2, are used to read and write an intended data field in the data registers, when the packet processing device 1-2 executes a packet processing program written by a firmware engineer. The instructions for the proposed device 1-2 have the same format as we exemplified in the first embodiment.

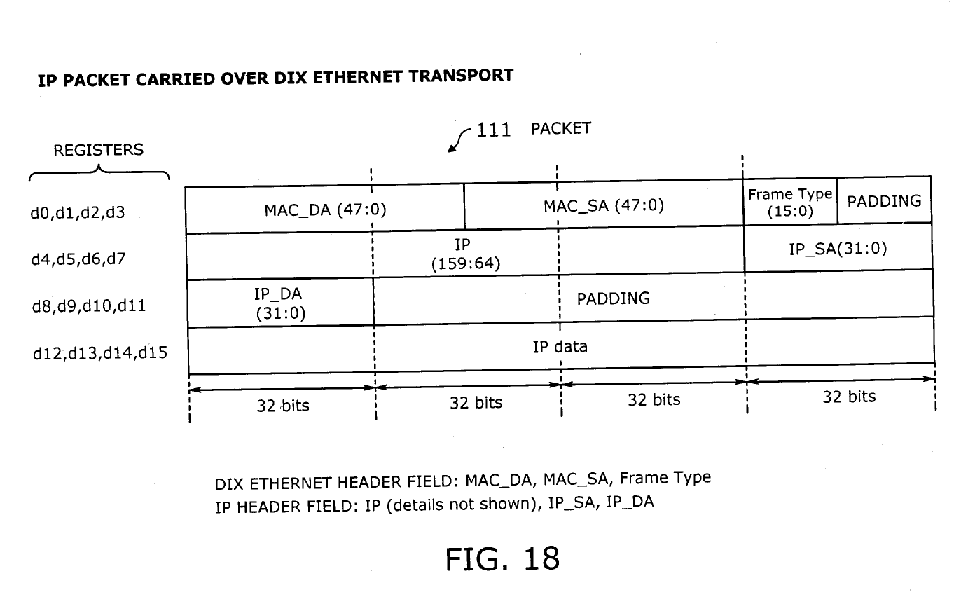

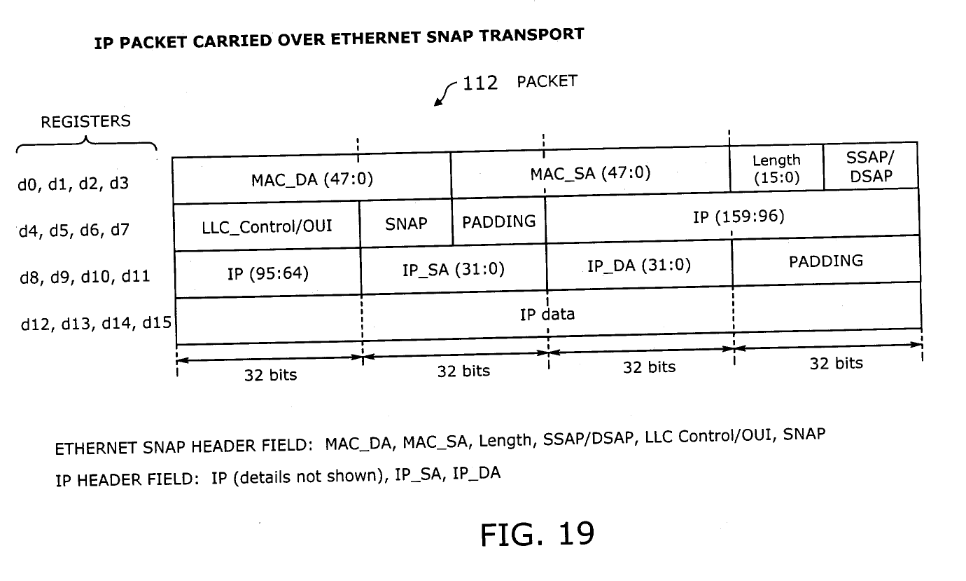

FIGS. 18 and 19 show two examples of a packet stored in the packet buffer 10 according to the second embodiment of the invention. Specifically, FIG. 18 gives a DIX Ethernet-encapsulated IP packet 111, while FIG. 19 shows an Ethernet SNAP-encapsulated IP packet 112. More specifically, in FIG. 18, the packet preprocessor has added a 16-bit padding word (PAD) at the end of the DIX Ethernet header, so that a subsequent IP header will begin at the MSB of data register d4. Referring to FIG. 19, a 16-bit padding word is inserted at the end of the Ethernet SNAP header, so that a subsequent IP header will begin at the MSB of data register d6. As can be seen from those diagrams, the packet preprocessor adjusts the alignment of protocol headers by placing padding words with appropriate lengths.

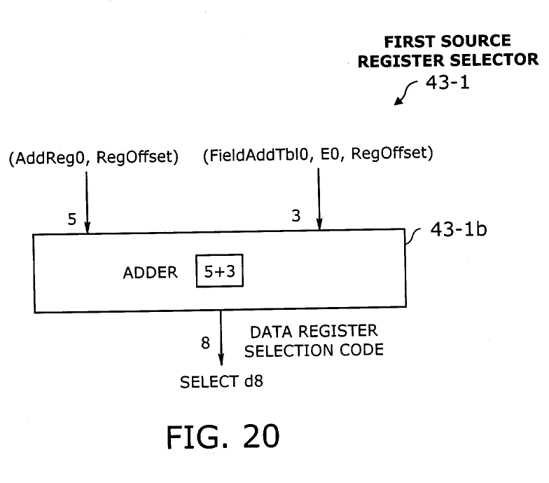

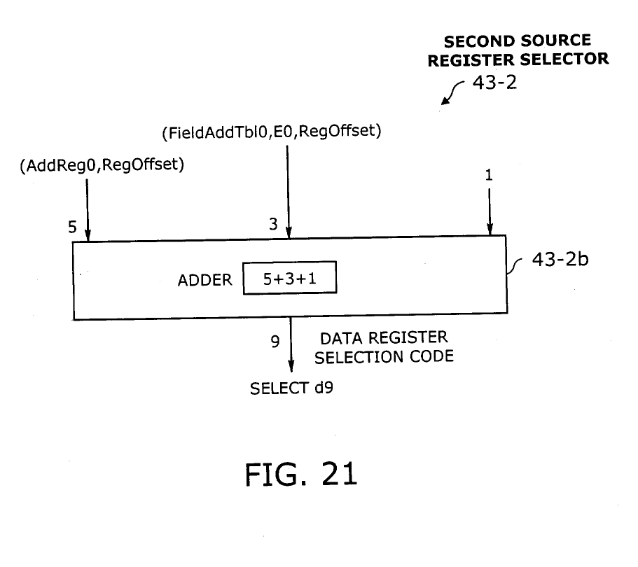

Referring now to FIGS. 20 and 21, the source register selectors used in the second embodiment are shown, which are simpler than those in the first embodiment described earlier in FIGS. 7 and 8. FIG. 20 shows a first source register selector 43-1, which is actually a simple adder 43-1b. This adder 43-1b calculates the sum of two parameters (AddReg0, RegOffset) and (FieldAddTb10, E0, RegOffset). Since the former is “5” and the latter is “3” in the present example, the adder 43-1b outputs “8,” meaning that data register d8 should be selected as the first source register.

FIG. 21 shows a second source register selector 43-2. This second source register selector 43-2 is actually a three-input adder 43-2b which calculates the sum of two parameters (AddReg0, RegOffset) and (FieldAddTb10, E0, RegOffset) and a constant “1.” In the present case, the former two parameters are “5” and “3,” the adder 43-2b outputs “9,” thus designating data register d9 as the second source register. As can be seen from this example, the first source register selector 43-1 selects a data register through a simple addition, and the second source register selector 43-2 selects a register that immediately follows the one selected by the first source register selector 43-1. Compared to the first embodiment, the source register selectors in the second embodiment can operate faster because of its reduced number of logic stages.

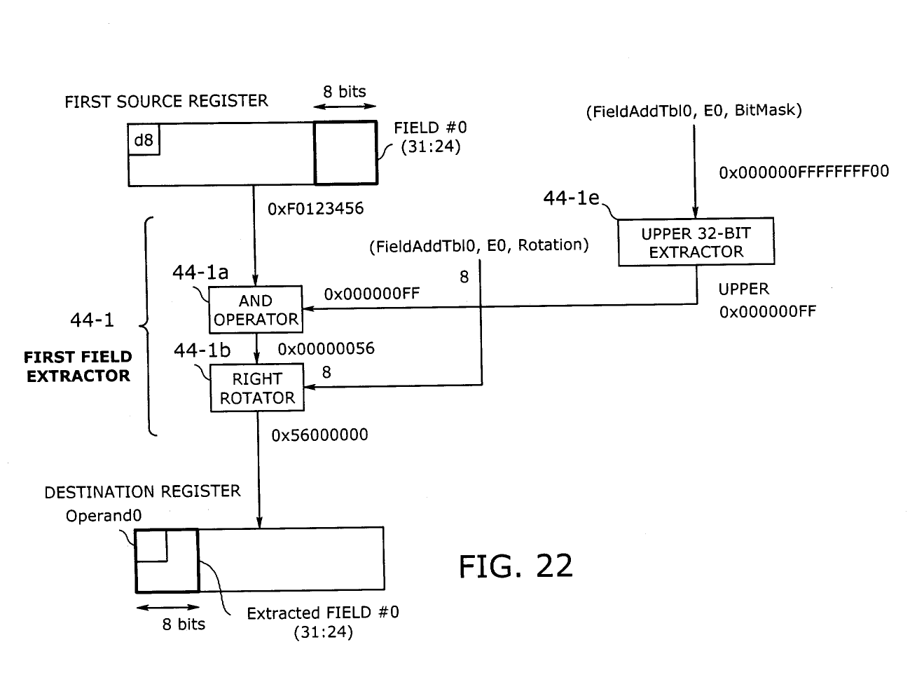

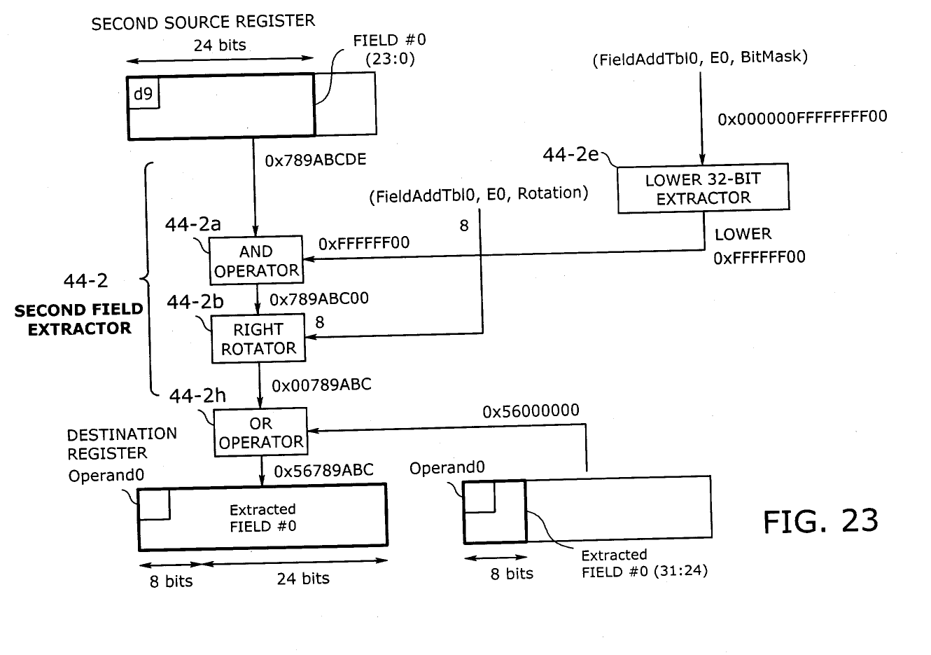

Referring to FIGS. 22 and 23, we will now describe field extractors used in the second embodiment, in comparison with those explained earlier in FIGS. 9 and 11. FIG. 22 shows the structure of a first field extractor 44-1. In the illustrated example, the role of the first field extractor 44-1 is to extract an upper part of field #0 from the lower 8 bits of data register d8 and saves in the top-most 8 bits of the destination register specified by Operand0.

To achieve the above function, the first field extractor 44-1 has an AND operator 44-1a, a right rotator 44-1b, and an upper 32-bit extractor 44-1e. The upper 32 bit extractor 44-1e outputs the upper 32 bits of (FieldAddTb10, E0, BitMask), which is now assumed to be “0x000000FFFFFFFF00.” This 32-bit value “0x000000FF” is used by the AND operator 44-1a to mask the first source register d8, which is assumed to be “0xF0123456” in the present example. The result is “0x00000056.” The right rotator 44-1b then rotates right it by a specified rotation count of (FieldAddTb10, E0, Rotation), which is “8” in the present case.

The above logic operation yields “0x56000000” out of the value “0xF0123456” of data register d8. This means that the first field extractor 44-1 has extracted the most significant 8 bits of field #0 from the first source register and set it to the most significant eight bits of the destination register specified by Operand0.

FIG. 23 shows the structure of a second field extractor 44-2. In the current context, the second field extractor 44-2 is supposed to extract the remaining 24 bits of field #0 from the second source register d9 and pack it in the lower 24-bit portion of the destination register specified by Operand0, assuming that the most significant eight bits of the destination register has been filled with the corresponding field data.

To achieve the above operation, the second field extractor 44-2 has an AND operator 44-2a, a right rotator 44-2b, a lower 32-bit extractor 44-2e, and an OR operator 44-2h. The lower 32-bit extractor 44-2e outputs the lower 32 bits of (FieldAddTb10, E0, BitMask), which is “0x000000FFFFFFFF00.” The extracted value “0xFFFFFF00” is used by the AND operator 44-2a to mask the second source register d9, which is assumed to be “0x789ABCDE” in the present example. The resultant value “0x789ABC00” is then subjected to the right rotator 44-2b, which rotates right it by a specified rotation count of (FieldAddTb10, E0, Rotation), which is “8” in the present case. The rotation produces “0x00789ABC.” Finally, the OR operator 44-2h combines this “0x00789ABC” with the current value “0x56000000” in the destination register, which has been set by the foregoing first field extractor 44-1. The destination register specified by Oprand0 is now filled with a value of “0x56789ABC,” just as in the first embodiment.

Through the above logic operations, the second field extractor 44-2 extracts lower 24 bits (“0x789ABC”) of field #0 from the upper part of the second source register d9 (“0x789ABCDE”) and combines them with the most significant eight bits (“0x56”) that have been extracted by the first field extractor 44-1, finally obtaining a full 32-bit value “0x56789ABC” of field #0 in the destination register specified by Operand0. As can be seen from FIGS. 22 and 23, the field extractors in the second embodiment can operate faster than those in the first embodiment because of the reduced number of logic stages.

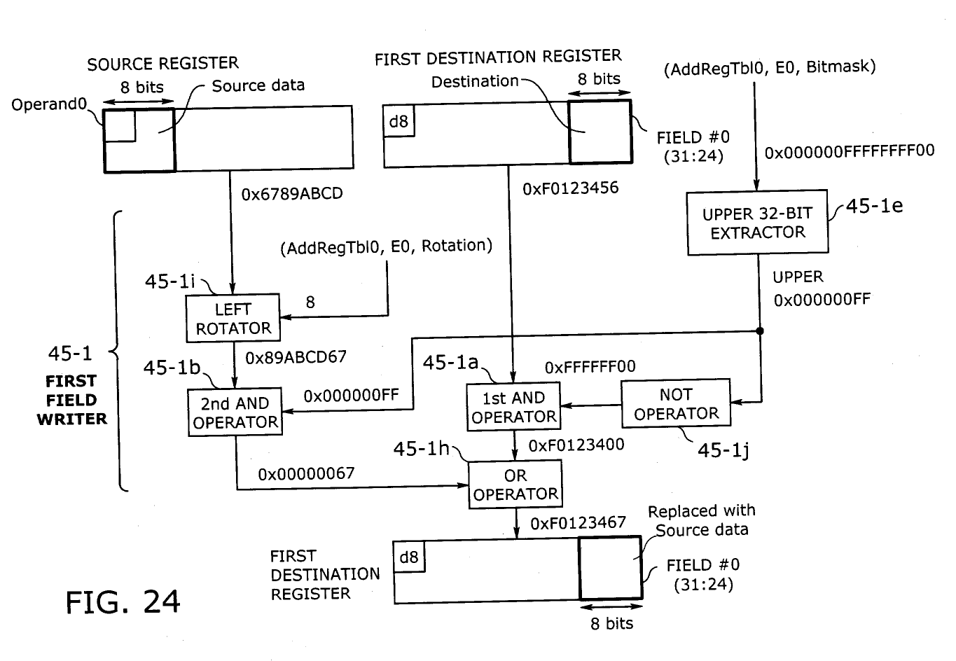

Referring now to FIG. 24, the following will explain field writers used in the second embodiment, comparing them with those explained earlier in FIGS. 13 and 14. Here we assume an instruction that fills field #0 in data registers d8 and d9 (see FIG. 17) with a source data specified by Operand0. In this context, a first field writer selectively replaces a relevant part of the first destination register d8 with a corresponding part of the source data, while leaving the remaining bits as they are. Likewise, a second field writer selectively replaces a relevant part of the second destination register d9 with the remaining source data.

FIG. 24 shows the structure of the first field writer in the second embodiment. To perform the above-described role, the illustrated first field writer 45-1 has a first AND operator 45-1a, a second AND operator 45-1b, an upper 32-bit extractor 45-1e, a OR operator 45-1h, a left rotator 45-1i, and a NOT operator 45-1j. The upper 32-bit extractor 45-1e receives a bit mask of (FieldAddTb10, E0, BitMask) and extracts its upper half, which is “0x000000FF” out of “0x000000FFFFFFFF00” in the present example. The extracted 32-bit mask pattern “0x000000FF” is negated by the NOT operator 45-1j, and the resulting pattern “0xFFFFFF00” is directed to the first AND operator 45-1a. Assuming that the first destination register d8 contains “0xF0123456,” the first AND operator 45-1a calculates the logical product of “0xF0123456” and “0xFFFFFF00,” thus obtaining “0xF0123400.”

The source register specified by Operand0, on the other hand, holds a value of “0x6789ABCD.” The left rotator 45-1i rotates left this source data by a specified rotation count of (FieldAddTb10, E0, Rotation), which is set to “8.” The resultant value “0x89ABCD67” is then sent to the second AND operator 45-1b and ANDed with the mask pattern “0x000000FF” extracted by the upper 32-bit extractor 45-1e, which results in a value of “0x00000067.” Finally, the OR operator 45-1h combines the outputs of the two AND operators 45-1a and 45-1b to provide write data for the first destination register d8. In the present example, two values “0xF0123400” and “0x00000067” are ORed into “0xF0123467.”

As a result of the above-described logic operations, the value of data register d8 has been changed from “0xF0123456” to “0xF0123467.” That is, the first field writer 45-1 has replaced selectively the lower eight bits of the first destination register d8 (where the upper eight bits of field #0 lie) with the upper eight bits of the source register specified by Operand0, while leaving the remaining bits of d8 as they are.

Although not shown in the accompanying drawings, the second field writer in the second embodiment is similar to the first field writer 45-1 described above, except that it employs a lower 32-bit extractor instead of the upper 32-bit extractor 45-1e. The second field writer, in the present context, fills the remaining part of field #0 (i.e., the upper 24 bits of the second destination register d9) with the lower 24 bits of the given source data.

As can be seen from FIG. 24, the field writers in the second embodiment are composed of fewer logic stages, compared to those in the first embodiment. The reduction in the number of logic stages enables them to operate faster, just as in the field extractors explained in FIGS. 22 and 23.

To summarize the above, the second embodiment employs a packet preprocessor which adds padding to a received packet to make its protocol headers aligned on data register boundaries, before passing it to the operation unit 40. This preprocessing simplifies subsequent logic operations at the operation unit 40 and thus speeds up the execution of a packet processing program, including read and write operations to header fields.

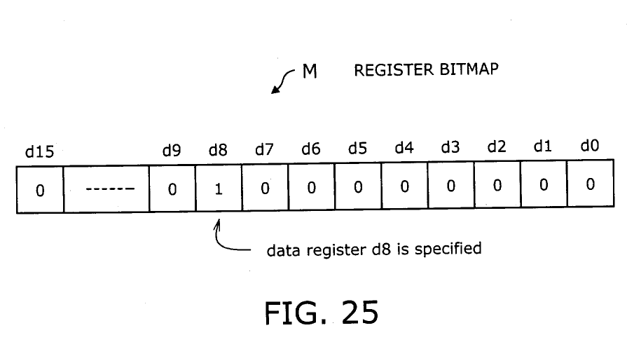

Referring now to FIGS. 25 to 27, we will describe a third embodiment of the present invention. The third embodiment differs from the preceding embodiments in the use of a register bitmap, instead of a numerically coded register offset, to select a data register.

FIG. 25 shows an example of a register bitmap. The illustrated bit map M is a 16-bit data word, one bit being set to one to indicate which data register to select. Bit #8 is set in this example, meaning that data register d8 shall be selected. Address registers in the third embodiment use this kind of bitmap expressions to point at protocol headers in a received packet. That is, they have a “RegBitMap” field to represent a register offset, instead of “RegOffset” in the first and second embodiments. Further, according to the third embodiment, the operation unit implements a bitmap producing function in its source register selectors and destination register selectors to designate a particular data register by a register bitmap.

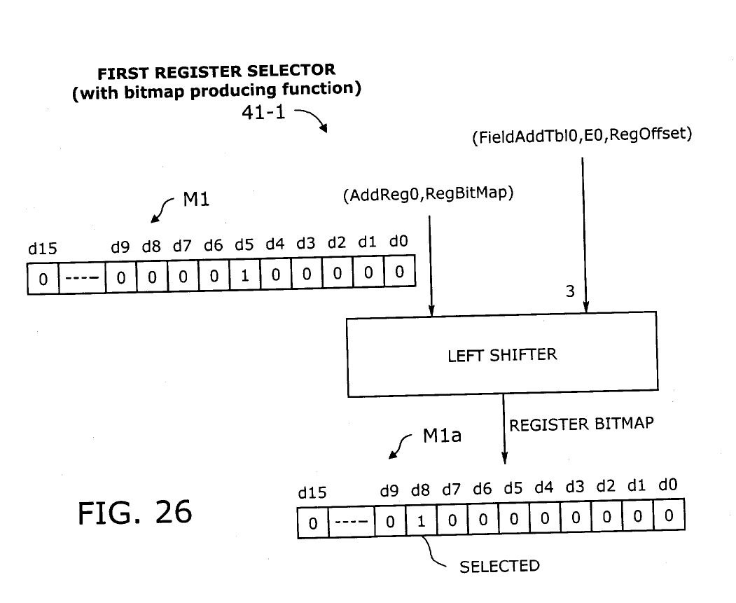

FIG. 26 shows the structure and operation of a first source register selector and a first destination register selector, which are collectively referred to as a “first register selector” 41-1. The illustrated first register selector 41-1 receives a register bitmap of (AddReg0, RegBitMap) from an address register AddReg0, the bit d5 of which is set to one. This bitmap M1 specifies data register d5 as the location of a protocol header of interest. Because the corresponding field address table FieldAddTb10 gives a field register offset (FieldAddTb10, E0, RegOffset) of “3,” the first register selector 41-1 shifts left the given register bitmap M1 by three bits. This shift operation yields a new register bitmap M1a whose eighth bit is set to one, meaning that data register d8 should be selected.

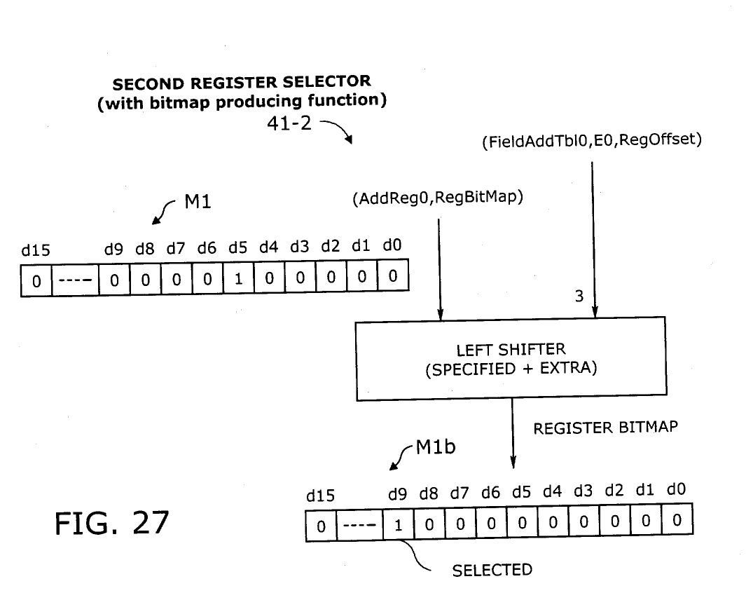

FIG. 27 shows the structure and operation of a second source register selector and a second destination register selector, which are collectively referred to as a “second register selector” 41-2. The illustrated second register selector 41-2 receives a register bitmap (AddReg0, RegBitMap) from an address register AddReg0, the bit d5 of which is set to one. This bitmap M1 specifies data register d5 as the location of a protocol header of interest. Since the corresponding field address table FieldAddTb10 gives a register offset of “3” (FieldAddTb10, E0, RegOffset), the second register selector 41-2 shifts left the given register bitmap M1 by four bits. Note that this shift count derives from the specified shift count “3” plus one extra shift. As a result, the second register selector 41-2 produces a new register bitmap M1b whose tenth bit is set to one, meaning that data register d9 should be selected.

As can be seen from the above explanation, the third embodiment eliminates addition and subtraction from the process of selecting a source or destination register. Instead, all register selections are performed in the form of fully decoded bitmaps, which is faster than using numeric expressions to identify individual registers. That is, the third embodiment is advantageous in terms of the speed of packet processing.

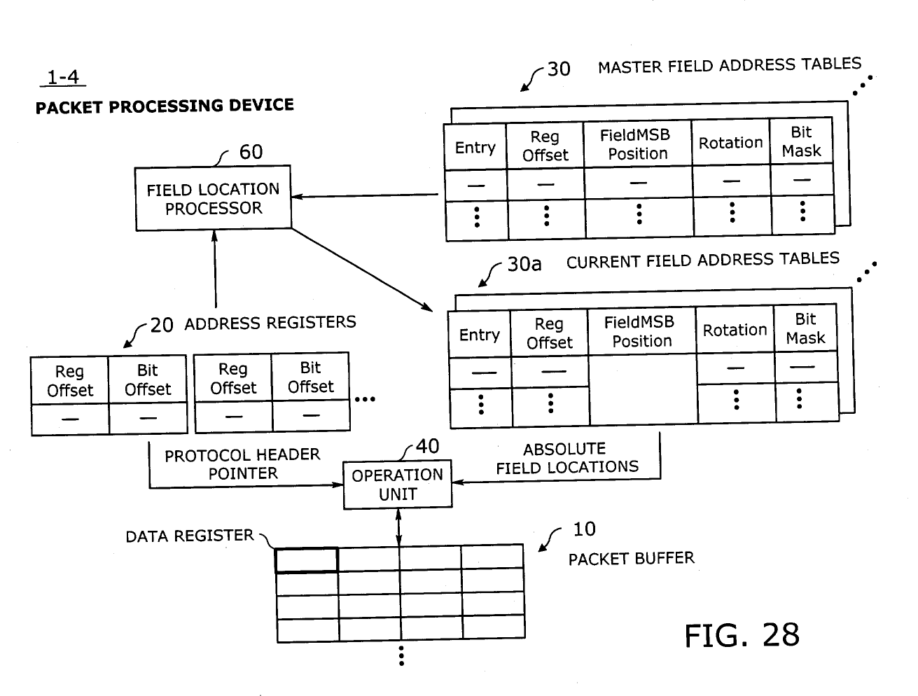

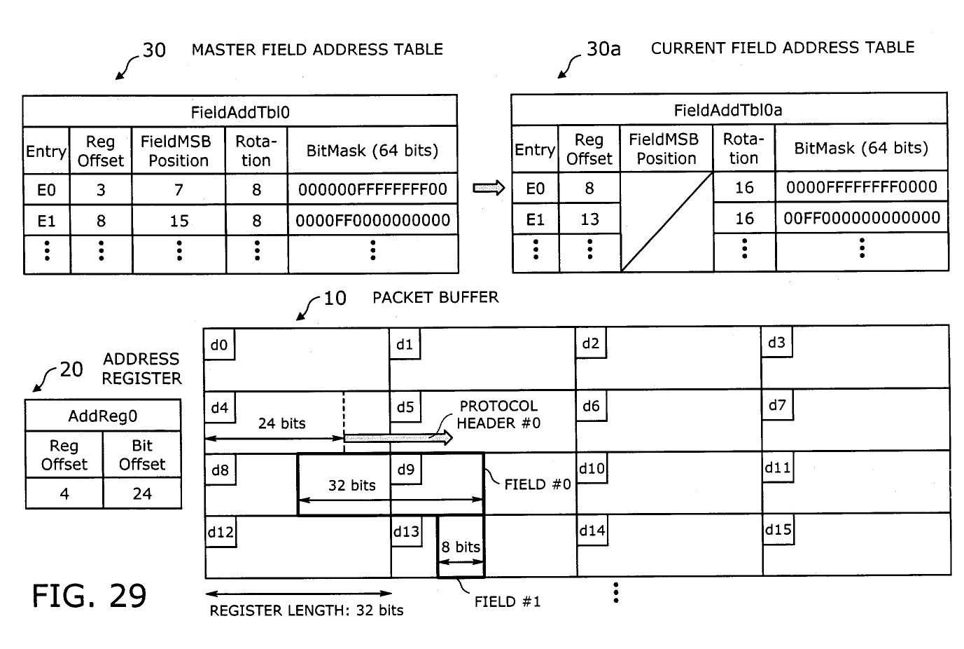

Referring now to FIGS. 28 and 29, we will describe a fourth embodiment of the present invention. FIG. 28 shows the concept of this fourth embodiment of the present invention, where field address tables are dynamically generated according to the current protocol header pointer. The illustrated packet processing device 1-4 has the following elements: a packet buffer 10, address registers 20, master field address tables 30, a field location processor 60, and current field address table 30a.

The field location processor 60 modifies field location parameters stored in the master field address tables 30 according to the current protocol header pointer, thereby compiling another version of field address tables 30a. The operation unit 40 processes incoming packets, based on the address registers 20 and current field address tables 30a. The master field address tables 30 are saved in some other storage space, so that they can be used when processing new packets.

FIG. 29 outlines how the fourth embodiment works. Here, the field location processor 60 produces a new field address table FieldAddTb10a by modifying parameters retrieved from the master field address table FieldAddTb10. As in the first and second embodiments, the master field address tables 30 are created under the assumption that every protocol header is neatly aligned on a data register boundary. The current field address tables 30a, on the other hand, provide real, absolute field locations in the packet buffer 10, which are calculated by the field location processor 60 based on the current packet data offset. Accordingly, field locations provided in the current field address table 30a are not necessarily aligned on data register boundaries.

Take the top-most entry of the current field address table FieldAddTb10a in FIG. 29, for example. This entry E0 gives the location of field #0 as follows:

(FieldAddTb10a, E0, RegOffset)=“8”

(FieldAddTb10a, E0, Rotation)=“16”

(FieldAddTb10a, E0, BitMask)=“0x0000FFFFFFFF0000”

While the field MSB position in the master field address table FieldAddTb10 is used to calculate those parameters, the current field address table FieldAddTb10a contains no values in its field MSB position field because they are not required in processing received packets.

The operation unit 40 processes a packet in the packet buffer 10, based on the current field address table FieldAddTb10a. Because FieldAddTb10a provides absolute position of each desired data field, there is no need to calculate the number of the source/destination register. It is no longer necessary for the operation unit 40 to consult “BitOffset” in the address registers 20 or “Field MSB Position” in the field address tables 30 in extracting data from, or writing data to, a particular header field. Actually, the operation unit 40 can reach the specified field #0 immediately, since the register offset value (FieldAddTb10a, E0, RegOffset)=“8” indicates that it resides in two data registers d8 and d9. Also the bit mask value (FieldAddTb10a, E0, BitMask)=“0x0000FFFFFFFF0000” suggests that the specified field #0 is stored in the lower 16 bits of d8 and upper 16 bits of d9. Further, the rotation account (FieldAddTb10a, E0, Rotation)=“16” indicates how to adjust field data alignment with data registers. Those field location parameters in the current field address table FieldAddTb10a permit the operation unit 40 to manipulate the specified field #0 more quickly.

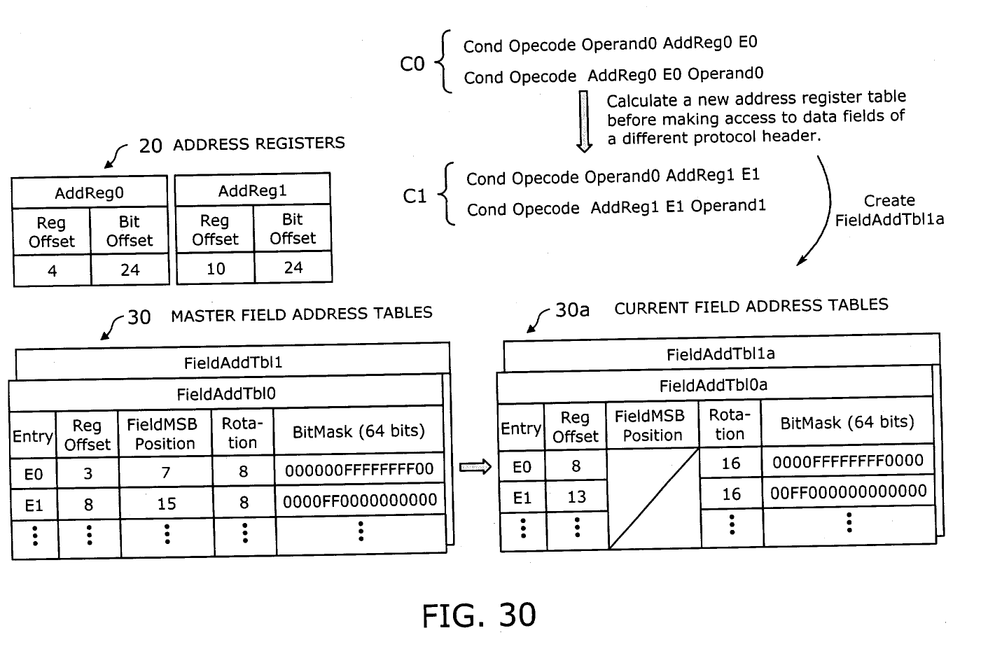

In the fourth embodiment explained in FIG. 29, the packet processing device 1-4 creates field address tables 30a each time a new packet is received. This concept may be slightly modified in such a way that the packet processing device 1-4 will produce a new field address table when it needs to make access to another protocol header as illustrated in FIG. 30. According to the illustrated example, the packet processing device 1-4 first executes a series of instructions C0 to process a protocol header #0 and then moves to another series of instructions C1 to process another protocol header #1. At the transition from C0 to C1, the field location processor 60 calculates parameters for the latter instructions C1, thus producing FieldAddTb11a as one of the current field address tables 30a.

Packet processing programs are supposed to have locality of reference about their access to protocol headers. That is, they tend to make repetitive access to data fields in one protocol header and then move their focus to another protocol header. The modified version of the fourth embodiment takes advantage of this property of programs. That is, it is faster and more efficient to calculate a field address table when the context is switched from one protocol header to another, rather than preparing an entire set of field address tables when a new packet is received.

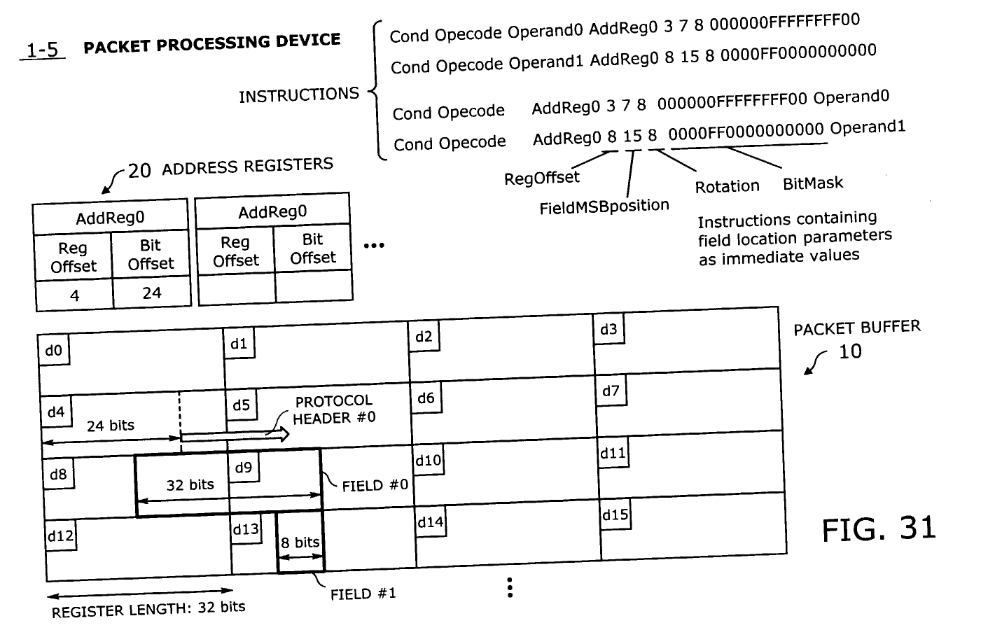

Referring lastly to FIG. 31, we will describe a fifth embodiment of the present invention. FIG. 31 shows the concept of this embodiment, where the packet processing program includes field location parameters as an immediate operand of instructions for execution by the operation unit 40. More specifically, the operation unit 40 executes such instructions as soon as they are fetched from microcode storage, without the need for consulting a field address table to obtain field location parameters corresponding to the entry number of interest. This arrangement contributes to faster execution of instructions.

To summarize the present invention described above, the proposed packet processing device is designed to manipulate received packets by using a protocol header pointer that indicates the location of a protocol header and field location parameters that indicate the location of each field of that header, while adjusting the alignment of fields with register boundaries. The firmware engineer can specify a desired field as a source operand or destination operand by designating a relevant address register and an entry of its associated field location table. Instructions constructed in such a way are not affected by the difference in protocol encapsulation structures.

Also, the proposed device may have a packet preprocessor that aligns protocol headers on register boundaries. This feature reduces the number of logic stages in the device's operation unit and thus increases the speed of packet processing. Further, address registers may provide protocol header pointers in bitmap form, rather than numerical form. Register bitmaps enable the operation unit to identify source and destination registers without the need for arithmetic operations such as addition or subtraction, thus speeding up the selection of data registers. The propose device may also have a field location processor that creates a field address table when a packet is received, or when the focus moves to another protocol header. This field address table makes subsequent packet processing operations easy and quick. The speed of packet processing can be further increased by allowing instructions to have immediate values for field location parameters, instead of specifying a field address table entry. While we have focused on packet processing devices, the proposed functions can be applied to other data processing devices that operate with a program or script.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A packet processing device for processing received packets with a series of instructions, comprising:
a packet buffer for storing a received packet, comprising a plurality of data registers with a fixed data length;
an address register storing a protocol header pointer indicating where in said packet buffer a protocol header starts;
a field address table storing field location parameters that indicate locations of fields constituting the protocol header and specify how to treat the fields; and
an operation unit which manipulates the received packet, adjusting alignment of each field on a data register boundary of said packet buffer according to the protocol header pointer in said address register and the field location parameters in said field address table, whereby the same series of instructions can be used to read and/or write a particular field in the protocol header, regardless of protocol stack structure of the received packet.

2. The packet processing device according to claim 1, wherein:
the protocol header pointer stored in said address register includes:
a register offset that indicates at which data register the protocol header starts, and
a bit offset that indicates at which bit in the starting data register the protocol header starts; and
for each field of interest in the protocol header, the field location parameters stored in said field address table include:
an entry number associated with the field,
a field register offset that indicates in which data register the most significant bit (MSB) of the field resides, assuming that the protocol header is aligned with a data register boundary,
a field MSB position that indicates at which bit of the MSB-containing data register the MSB of the field is located,
a rotation count that indicates how many bits the field should be rotated in order to obtain a correct alignment of the field, and
a bit mask that indicates in which portion of the data register(s) the field occupies.

3. The packet processing device according to claim 2, wherein, to execute an instruction that loads data from a specified field in said packet buffer to a destination register, said operation unit comprises:
a source register selector which identifies, from among said data registers, at least one source register containing the specified field, according to the protocol header pointer and field location parameters; and
a field extractor which extracts the specified field from the identified source register(s) according to the protocol header pointer and field location parameters.

4. The packet processing device according to claim 3, wherein, to enable said operation unit to read a field that lies across two consecutive data registers, said source register selector comprises:
(a) a first source register selector that identifies a first source register, comprising:
a subtractor that subtracts the bit offset from the field MSB position and outputs a borrow if the minuend is smaller than the subtrahend, and
an adder that calculates a sum of the register offset, the field register offset, and the borrow output of said subtractor, the sum indicating which data register to designate as the first source register; and
(b) a second source register selector that identifies a second source register by incrementing the outcome of said first source register selector by one.

5. The packet processing device according to claim 4, wherein said field extractor comprises:
a first field extractor that extracts one part of the specified field from the first source register and inserts the extracted part of the field to a first part of the destination register; and
a second field extractor that extracts the other part of the specified field from the second source register and inserts the other part of the field to a second part of the destination register.

6. The packet processing device according to claim 5, wherein said first field extractor comprises:
a subtractor that subtracts the bit offset from the field MSB position and outputs a borrow if the minuend is smaller than the subtrahend;
a first right rotator that rotates right the bit mask by a number given as the bit offset;
an upper/lower bit splitter that divides the rotated bit mask into an upper part and a lower part;
a selector that selects either the upper part or lower part of the rotated bit mask, depending on the borrow output of said subtractor;
an AND operator that calculates a logical product of the first source register and the output of said selector;
a second right rotator that rotates right the output of said AND operator by the rotation count; and
a left rotator that rotates left the output of the second right rotator by a number given as the bit offset.

7. The packet processing device according to claim 5, wherein said second field extractor comprises:
a subtractor that subtracts the bit offset from the field MSB position and outputs a borrow if the minuend is smaller than the subtrahend;
a first right rotator that rotates right the bit mask by a number given as the bit offset;
an upper/lower bit splitter that divides the rotated bit mask into an upper part and a lower part;
a selector that selects either the upper part or lower part of the rotated bit mask, depending on the borrow output of said subtractor;
an AND operator that calculates a logical product of the second source register and the output of said selector;
a second right rotator that rotates right the output of said AND operator by the rotation count;
a left rotator that rotates left the output of the second right rotator by the number given as the bit offset; and
an OR operator that calculates a logical sum of the output of said left rotator and the output of said first field extractor.

8. The packet processing device according to claim 2, wherein, to execute an instruction that fills a specified field in said packet buffer with data given in a source register, said operation unit comprises:
a destination register selector which identifies, from among said data registers, at least one destination register where the specified field lies, according to the protocol header pointer and field location parameters; and
a field writer which fills the specified field in the identified destination register(s) with the data in the source register, according to the protocol header pointer and field location parameters.

9. The packet processing device according to claim 8, wherein, to enable said operation unit to write data to a specified field that lies across two consecutive data registers, said destination register selector comprises:
(a) a first destination register selector that identifies a first destination register, comprising:
a subtractor that subtracts the bit offset from the field MSB position and outputs a borrow if the minuend is smaller than the subtrahend, and
an adder that calculates a sum of the register offset, the field register offset, and the borrow output of said subtractor, the sum indicating which data register to designate as the first destination register; and
(b) a second destination register selector that identifies a second destination register by incrementing the outcome of said first destination register selector by one.

10. The packet processing device according to claim 9, wherein said field writer comprises:
a first field writer that replaces one part of the specified field in the first destination register with a first part of the source register; and
a second field writer that replaces the other part of the specified field in the first destination register with a second part of the source register.

11. The packet processing device according to claim 10, wherein said first field writer comprises:
a subtractor that subtracts the bit offset from the field MSB position and outputs a borrow if the minuend is smaller than the subtrahend;
a first right rotator that rotates right the bit mask by a number given as the bit offset;
an upper/lower bit splitter that divides the output of said first right rotator into an upper part and a lower part;
a selector that selects either the upper part or the lower part, depending on the borrow output of said subtractor;
a NOT operator that logically negates the output of said selector;
a first AND operator that calculates a logical product of the first destination register and the output of said NOT operator;
a second right rotator that rotates right the source register by a number given as the bit offset;
a left rotator that rotates left the output of the second right rotator by a number given as the rotation count;
a second AND operator that calculates a logical product of the outputs of said left rotator and said selector; and
an OR operator that calculates a logical sum of the outputs of said first and second AND operators.

12. The packet processing device according to claim 10, wherein said second field writer comprises:
a subtractor that subtracts the bit offset from the field MSB position and outputs a borrow if the minuend is smaller than the subtrahend;
a first right rotator that rotates right the bit mask by a number given as the bit offset;
an upper/lower bit splitter that divides the output of said first right rotator into an upper part and a lower part;
a selector that selects either the upper part or lower part of the rotated bit mask, depending on the borrow output of said subtractor;
a NOT operator that logically negates the output of said selector;
a first AND operator that calculates a logical product of the second destination register and the output of said NOT operator;
a second right rotator that rotates right the source register by a number given as the bit offset;
a left rotator that rotates left the output of the second right rotator by a number given as the rotation count;
a second AND operator that calculates a logical product of the outputs of said left rotator and said selector; and
an OR operator that calculates a logical sum of the outputs of said first and second AND operators.

13. The packet processing device according to claim 1, further comprising a packet preprocessor that adds padding to a received packet in such a way that each protocol header in the padded packet will be aligned on a data register boundary.

14. The packet processing device according to claim 13, wherein:
the protocol header pointer stored in said address register includes a register offset that indicates at which data register the protocol header starts; and
for each field of interest in the protocol header, the field location parameters stored in said field address table include:
an entry number associated with the field,
a field register offset that indicates in which data register the most significant bit (MSB) of the field resides,
a rotation count that indicates how many bits the field should be rotated, and
a bit mask that indicates in which portion of the data register(s) the field occupies.

15. The packet processing device according to claim 14, wherein to execute an instruction that loads data from a specified field in said packet buffer to a destination register, said operation unit comprises:
a source register selector which identifies, from among said data registers, at least one source register containing the specified field, according to the protocol header pointer and field location parameters; and
a field extractor which extracts the specified field from the identified source register(s) according to the protocol header pointer and field location parameters.

16. The packet processing device according to claim 15, wherein, to enable said operation unit to read a field that lies across two consecutive data registers, said source register selector comprises:
a first source register selector that identifies a first source register, comprising an adder that calculates a sum of the register offset and the field register offset, the sum indicating which data register to designate as the first source register; and
a second source register selector that identifies a second source register by incrementing the outcome of said first source register selector by one.

17. The packet processing device according to claim 16, wherein said field extractor comprises:
a first field extractor that extracts one part of the specified field from the first source register and inserts the extracted part of the field to a first part of the destination register; and
a second field extractor that extracts the other part of the specified field from the second source register and inserts the other part of the field to a second part of the destination register.

18. The packet processing device according to claim 17, wherein said first field extractor comprises:
an upper bit extractor that extracts upper bits of the bit mask;
an AND operator that calculates a logical product of the first source register and the upper bits extracted by said upper bit extractor; and
a second right rotator that rotates right the output of said AND operator by the rotation count.

19. The packet processing device according to claim 17, wherein said second field extractor comprises:
a lower bit extractor that extracts lower bits of the bit mask;
an AND operator that calculates a logical product of the second source register and the lower bits extracted by said upper bit extractor;
a right rotator that rotates right the output of said AND operator by the rotation count; and
an OR operator that calculates a logical sum of the output of said right rotator and the output of said first field extractor.

20. The packet processing device according to claim 14, wherein, to execute an instruction that fills a specified field in said packet buffer with data given in a source register, said operation unit comprises:
a destination register selector which identifies, from among said data registers, at least one destination register where the specified field lies, according to the protocol header pointer and field location parameters; and
a field writer which replaces the specified field in the identified destination register(s) with the data in the source register, according to the protocol header pointer and field location parameters.

21. The packet processing device according to claim 20, wherein, to enable said operation unit to write data to a specified field that lies across two consecutive data registers, said destination register selector comprises:
a first destination register selector that identifies a first destination register, comprising an adder that calculates a sum of the register offset and the field register offset, the sum indicating which data register to designate as the first destination register; and
a second destination register selector that identifies a second destination register by incrementing the outcome of said first destination register selector by one.

22. The packet processing device according to claim 21, wherein said field writer comprises:
a first field writer that replaces one part of the specified field in the first destination register with a first part of the source register; and
a second field writer that replaces the other part of the specified field in the first destination register with a second part of the source register.

23. The packet processing device according to claim 22, wherein said first field writer comprises:
an upper bit extractor that extracts upper bits of the bit mask;
a NOT operator that logically negates the extracted upper bits of the bit mask;
a first AND operator that calculates a logical product of the first destination register and the output of said NOT operator;
a left rotator that rotates left the source register by a number given as the rotation count;
a second AND operator that calculates a logical product of the output of said left rotator and the extracted upper bits of the bit mask; and
an OR operator that calculates a logical sum of the outputs of said first and second AND operators.

24. The packet processing device according to claim 22, wherein said second field writer comprises:
a lower bit extractor that extracts lower bits of the bit mask;
a NOT operator that logically negates the extracted lower bits of the bit mask;
a first AND operator that calculates a logical product of the first destination register and the output of said NOT operator;
a left rotator that rotates left the source register by a number given as the rotation count;
a second AND operator that calculates a logical product of the output of said left rotator and the extracted lower bits of the bit mask; and
an OR operator that calculates a logical sum of the outputs of said first and second AND operators.

25. The packet processing device according to claim 1, wherein:
the protocol header pointer in the address register is represented in bitmap form; and
said operation unit uses the bitmap to select data registers.

26. The packet processing device according to claim 1, further comprising a field location processor that calculates a modified version of the field address table that contains field location parameters indicating absolute locations of the fields in the packet buffer, regardless of misalignment of the protocol header with data register boundaries, each time a new packet is received or each time the packet processing device starts to manipulate a different protocol header.

27. A packet processing device for processing received packets with a series of instructions, comprising:
a packet buffer for storing a received packet, comprising a plurality of data registers with a fixed data length;
an address register storing a protocol header pointer indicating where in said packet buffer a protocol header starts; and
an operation unit which manipulates the received packet, adjusting alignment of each field on a data register boundary of said packet buffer according to the protocol header pointer in said address register in conjunction with field location parameters contained as immediate operands in the instructions to indicate locations of fields constituting the protocol header and specify how to treat the fields, whereby the same series of instructions can be used to read and/or write a particular field in the protocol header, regardless of protocol stack structure of the received packet.

28. A method of processing received packets with a series of instructions, comprising the steps of:
storing a received packet in a packet buffer comprising a plurality of data registers with a fixed data length;
storing protocol header pointer indicating where in the packet buffer a protocol header starts;
storing field location parameters that indicate locations of fields constituting the protocol header and specify how to treat the fields; and
manipulating the received packet, adjusting alignment of each field on a data register boundary of the packet buffer according to the protocol header pointer and field location parameters being stored, whereby the same series of instructions can be used to read and/or write a particular field in the protocol header, regardless of protocol stack structure of the received packet.

29. A packet routing device which forwards packets over a network, comprising:
(a) a packet processing device, comprising:
a packet buffer for storing a received packet, comprising a plurality of data registers with a fixed data length,
an address register storing protocol header pointer indicating where in said packet buffer a protocol header starts,
a field address table storing field location parameters that indicate locations of fields constituting the protocol header and specify how to treat the fields, and
an operation unit which manipulates the received packet, adjusting alignment of each field on a data register boundary of said packet buffer according to the protocol header pointer in said address register and the field location parameters in said field address table, whereby the same series of instructions can be used to read and/or write a particular field, regardless of protocol stack structure of the received packet; and
(b) a packet forwarding controller that forwards received packets toward destinations thereof, based on results of processing by said packet processing device.
